(19) United States
(12) Patent Application Publication
(10) Pub. No.: US 2025/0328004 A1
(43) Pub. Date: Oct. 23, 2025

(54) Stack-Integrated Metasurface Devices and Sequential Damascene Manufacturing Processes

(71) Applicant: Lumotive, Inc., Redmond, WA (US)

(72) Inventors: Gleb M. Akselrod, Kenmore, WA (US); Lie "Larry" Zhao, Washougal, WA (US); Erik Edward Josberger, Renton, WA (US); Linda Gail Conway, Duvall, WA (US)

(21) Appl. No.: 18/642,422

(22) Filed: Apr. 22, 2024

(51) Int. Cl. G02B 26/00; G02B 1/00; G02B 26/08; G02F 1/137

(52) U.S. Cl. CPC G02B 26/001; G02B 1/002; G02B 26/0875; G02F 1/13731

(57) ABSTRACT

The disclosure includes an optical metasurface with an optical reflector layer and a resonator layer. The resonator layer includes an array of optical resonators extending vertically with respect to the optical reflector layer. Each optical resonator may be formed by two stack-integrated metallic optical elements positioned adjacent to each other to create a gap. The stack-integrated metallic optical elements may include a base metallic optical element and one or more stacked metallic optical elements.

### TECHNICAL FIELD

This disclosure relates to optical metasurfaces, including tunable optical metasurfaces. More specifically, this disclosure relates to metasurfaces incorporating one-dimensional and two-dimensional arrays of tunable optical resonators.

### BRIEF DESCRIPTION OF THE DRAWINGS

FIG. 1 illustrates an example of a metasurface that is steerable in one dimension, according to one embodiment.

FIG. 2 illustrates a perspective view of a simplified block diagram of reflective and resonator layers of a two-dimensional optical metasurface, according to one embodiment.

FIG. 3 illustrates a side-view diagram of the layers of a portion of a tunable optical metasurface, according to one embodiment.

FIG. 4A illustrates an example diagram of two anti-nodes of an optical field in an optical resonator of a tunable optical metasurface, according to one embodiment.

FIG. 4B illustrates the tunable dielectric material between two pillars aligned in a first direction to provide a first refractive index without any applied voltage, according to one embodiment.

FIG. 4C illustrates the tunable dielectric material between the pillars aligned in a second direction to provide a second refractive index with an applied voltage of 5 volts, according to one embodiment.

FIG. 4D illustrates a graph of a phase response of the optical resonator of FIG. 4A with respect to applied voltage values, according to one embodiment.

FIG. 5A illustrates an example diagram of three anti-nodes of an optical field in an optical resonator with a relatively high aspect ratio, according to one embodiment.

FIG. 5B illustrates a graph of a phase response of the optical resonator of FIG. 5A with respect to applied voltage values, according to one embodiment.

FIG. 6A illustrates an example diagram of six anti-nodes of an optical field in an optical resonator with an even higher aspect ratio, according to one embodiment.

FIG. 6B illustrates a graph of a phase response of the optical resonator of FIG. 6A with respect to applied voltage values, according to one embodiment.

FIG. 7A illustrates a metallic via within the via layer to connect a reflector of the reflector layer to a metallic optical element of the optical resonator layer, according to one embodiment.

FIGS. 7B-7G illustrate block diagrams of a single-damascene process to form a base metallic optical element of a stack-integrated optical resonator, according to one embodiment.

FIGS. 8A-8F illustrate a single-damascene process to form a stacked metallic optical element with a metallic barrier connection, according to one embodiment.

FIG. 9 illustrates an example of a high-aspect-ratio optical resonator formed with stack-integrated metallic optical elements, according to one embodiment.

FIGS. 10A-10G illustrate another single-damascene process to form a stacked metallic optical element with a selectively deposited and removed metallic barrier, according to one embodiment.

FIG. 11 illustrates an example of a high-aspect-ratio optical resonator formed with stack-integrated metallic optical elements, according to one embodiment.

FIGS. 12A-12F illustrate another single-damascene process to form a stacked metallic optical element without a metallic barrier, according to one embodiment.

FIG. 13 illustrates an example of a uniformly tapered high-aspect-ratio optical resonator formed with stack-integrated metallic optical elements, according to one embodiment.

FIG. 14 illustrates a perspective view of a simplified block diagram of a metasurface that is steerable in one dimension with stack-integrated metallic optical elements forming high-aspect ratio optical resonators, according to one embodiment.

FIG. 15 illustrates a perspective view of a simplified block diagram of a metasurface with stack-integrated metallic optical elements forming high-aspect ratio optical resonators, according to one embodiment.

### DETAILED DESCRIPTION

According to various embodiments, a metasurface includes a one-dimensional or two-dimensional array of optical resonators. The metasurface may include an optical reflector layer to reflect electromagnetic radiation within an operational bandwidth, a resonator layer with optical resonators extending vertically therein, and an interconnect layer with metallic vias to selectively connect metallic optical elements of the optical resonators to reflector patches of the reflector layer. In various embodiments, the optical reflector layer includes a plurality of metallic reflector patches (e.g., copper). In various embodiments, each optical resonator of the resonator layer is formed by two vertically extending stack-integrated metallic optical elements (e.g., copper) positioned adjacent to one another to form a gap between them. In various embodiments, the interconnect layer is positioned between the optical reflector layer and the resonator layer and includes a plurality of metallic vias. Each metallic via may, for example, electrically connect one of the metallic optical elements of the resonator layer with one of the metallic reflector patches of the optical reflector layer.

According to various examples, each stack-integrated metallic optical element includes at least a base metallic optical element and one or more stacked metallic optical elements. The base metallic optical element of each stack-integrated metallic optical element may be formed during a first single-damascene manufacturing process. In some embodiments, the base metallic optical element of each stack-integrated metallic optical element may be formed during a dual-damascene manufacturing process. In such embodiments, the dual-damascene manufacturing process may be used to form the base metallic optical elements together with the vias in an underlying interconnect or via layer. Each subsequent stacked metallic optical element may be formed as part of a sequence of distinct single-damascene manufacturing processes. Each stack-integrated metallic optical element may extend to a height that is at least four times greater than the smallest width thereof, such that each stack-integrated metallic optical element has an aspect ratio of at least 4:1.

For example, the base metallic optical element of each stack-integrated metallic optical element may have an aspect ratio of at least 3:1, and the first stacked metallic optical element of each stack-integrated metallic optical element may have an aspect ratio of at least 2:1, such that each stack-integrated metallic optical element has an aspect ratio of at least 5:1. In another example, a base metallic optical element, a first stacked metallic optical element, and a second stacked metallic optical element each have an aspect ratio of at least 2:1, such that the triple-stacked stack-integrated metallic optical element has an aspect ratio of at least 6:1.

This disclosure may be understood by reference to the following detailed description, taken in conjunction with the drawings as described below. It is noted that, for purposes of illustrative clarity, certain elements in various drawings may not be drawn to scale, and other elements may be omitted to avoid obscuring the focus of this application.

Additional descriptions, variations, functionalities, and usages for optical metasurfaces are described in U.S. Pat. No. 10,451,800 granted on Oct. 22, 2019, entitled “Plasmonic Surface-Scattering Elements and Metasurfaces for Optical Beam Steering;” U.S. Pat. No. 10,665,953 granted on May 26, 2020, entitled “Tunable Liquid Crystal Metasurfaces;” and U.S. Pat. No. 11,092,675 granted on Aug. 17, 2021, entitled “Lidar Systems based on Tunable Optical Metasurfaces,” each of which is hereby incorporated by reference in its entirety. Many of the metasurfaces described in the above-identified U.S. patents include one-dimensional arrays of parallel rails, two-dimensional arrays of elongated rails, and/or two-dimensional arrays of pillars positioned above a planar reflective surface, reflective layers, or optically transmissive surfaces.

This disclosure includes various embodiments and variations of tunable optical metasurface devices and methods for manufacturing the same. It is appreciated that the metasurface technologies described herein may incorporate or otherwise leverage prior advancements in surface scattering antennas, such as those described in U.S. Patent Publication No. 2012/0194399, published on Aug. 2, 2012, entitled “Surface Scattering Antennas;” U.S. Patent Publication No. 2019/0285798 published on Sep. 19, 2019, entitled “Plasmonic Surface-Scattering Elements and Metasurfaces for Optical Beam Steering;” and U.S. Patent Publication No. 2018/0241131 published on Aug. 23, 2018, entitled “Optical Surface-Scattering Elements and Metasurfaces;” each of which is hereby incorporated by reference in its entirety. Additional elements, applications, and features of surface scattering antennas are described in U.S. Patent Publication No. 2014/0266946, published Sep. 18, 2014, entitled “Surface Scattering Antenna Improvements;” U.S. Patent Publication No. 2015/0318618, published Nov. 5, 2015, entitled “Surface Scattering Antennas with Lumped Elements;” U.S. Patent Publication No. 2015/0318620 published Nov. 5, 2015, entitled “Curved Surface Scattering Antennas;” U.S. Patent Publication No. 2015/0380828 published on Dec. 31, 2015, entitled “Slotted Surface Scattering Antennas;” U.S. Patent Publication No. 2015/0162658 published Jun. 11, 2015, entitled “Surface Scattering Reflector Antenna;” U.S. Patent Publication No. 2015/0372389 published Dec. 24, 2015, entitled “Modulation Patterns for Surface Scattering Antennas;” PCT Application No. PCT/US18/19269 filed on Feb. 22, 2018, entitled “Control Circuitry and Fabrication Techniques for Optical Metasurfaces,” U.S. Patent Publication No. 2019/0301025 published on Oct. 3, 2019, entitled “Fabrication of Metallic Optical Metasurfaces;” U.S. Publication No. 2018/0248267 published on Aug. 30, 2018, entitled “Optical Beam-Steering Devices and Methods Utilizing Surface Scattering Metasurfaces;” U.S. Pat. No. 11,429,008 granted on Aug. 30, 2022, entitled “Liquid Crystal Metasurfaces with Cross-Backplane Optical Reflectors;” and U.S. Pat. No. 11,960,155 granted on Apr. 16, 2024, entitled “Two-Dimensional Metasurfaces with Integrated Capacitors and Active-Matrix Driver Routing,” each of which is hereby incorporated by reference in its entirety.

In various embodiments, the elongated metal rails, pillars, or other metallic extension structures (e.g., metallic optical elements) have subwavelength dimensions suitable for operation within a specific bandwidth of optical frequencies (e.g., a bandwidth of infrared optical frequencies). The width of each metallic optical element may be, for example, less than the smallest wavelength of the operational bandwidth.

Tunable optical metasurfaces may be used for beamforming, including three-dimensional beam shaping, two-dimensional beam steering, and/or one-dimensional beam steering. The presently described systems and methods can be applied to tunable metasurfaces utilizing various architectures and designs to deflect optical radiation within an operational bandwidth. In various embodiments, a controller or metasurface driver selectively applies a pattern of voltages to an array of optical structures. Voltage differentials across adjacent optical structures modify the refractive indices of dielectric material therebetween. A combination of phase delays created by the pattern of applied voltages creates constructive interference in the desired beam steering direction. The voltages are, for example, conveyed by the metallic vias to the metallic optical elements forming the tunable optical resonators. In some embodiments, the metallic vias connect the metallic optical elements to reflector patches of the reflector layer. In such embodiments, the reflector patches are then connected to the control lines of a driver, capacitors, transistors, and/or other driver components to selectively drive voltage differentials across the various tunable optical resonators.

Various examples of tunable optical metasurfaces are described herein and depicted in the figures. For example, a tunable optical metasurface includes an array of metal extension elements (e.g., antenna elements, resonator elements, elongated resonator rails, arrays of metal pillars, pairs of resonator pillars, etc. that extend from a dielectric substrate above a metallic reflector). For instance, in some embodiments, the array of metal elements comprises a one-dimensional array of elongated metal resonator rails arranged parallel to one another with respect to an optical reflector, such as an optically reflective layer of metal or a Bragg reflector. Liquid crystal, or another refractive index tunable dielectric material, is positioned in the gaps or channels between adjacent resonator rails (e.g., adjacent elongated metal rails). Liquid crystal is used in many of the examples provided in this disclosure. However, it is appreciated that an alternative dielectric material with a tunable refractive index and/or combinations of different dielectric materials with tunable refractive indices may be utilized instead of liquid crystal. Examples of suitable tunable dielectric materials that have tunable refractive indices include liquid crystals, electro-optic polymer, chalcogenide glasses, and/or various semiconductor materials.

In various embodiments, biasing the liquid crystal in a metasurface with a pattern of voltage biases changes the reflection phase of the optical radiation. For example, each different voltage pattern applied across the metasurface corresponds to a different reflection phase pattern. Each different reflection phase pattern of a one-dimensional array of optical structures (e.g., elongated metal resonator rails) corresponds to a different steering angle in a single dimension. A digital or analog controller (controlling current and/or voltage), such as a metasurface driver, may apply a differential voltage bias pattern to achieve a target beam shaping, such as a target beam steering angle. The term “beam shaping” is used herein in a broad sense to encompass one-dimensional beam steering, two-dimensional beam steering, wavelength filtering, beam divergence, beam convergence, beam focusing, and/or controlled deflection, refraction, and/or reflection of incident optical radiation.

Various examples and metal elements, such as elongated metal rails and metal pillars, are illustrated and described in many instances as being copper or as including copper (e.g., a copper alloy). Copper antenna elements may, for example, be fabricated using sequential single-damascene processes for semiconductor devices. However, it is appreciated that other metals may also be utilized, including but not limited to tungsten, aluminum, copper alloys, and/or combinations thereof.

Any of the variously described embodiments herein may be manufactured with dimensions suitable for optical bandwidths for optical sensing systems such as LiDAR, optical communications systems, optical computing systems, and displays. For example, the systems and methods described herein can be configured with metasurfaces that operate in the sub-infrared, mid-infrared, high-infrared, and/or visible-frequency ranges (generally referred to herein as “optical”). Given the feature sizes needed for sub-wavelength optical antennas and antenna spacings, the described metasurfaces may be manufactured using micro-lithographic and/or nano-lithographic processes, such as fabrication methods commonly used to manufacture complementary metal-oxide-semiconductor (CMOS) integrated circuits.

The components of some of the disclosed embodiments are described and illustrated in the figures herein to provide specific examples. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure. The right to add any described embodiment or feature to any one of the figures and/or as a new figure is explicitly reserved.

The embodiments of the systems and methods provided within this disclosure are not intended to limit the scope of the disclosure but are merely representative of possible embodiments. In addition, the steps of a method do not necessarily need to be executed in any specific order or even sequentially, nor do the steps need to be executed only once, except as explicitly stated or as contextually understood by one of skill in the art.

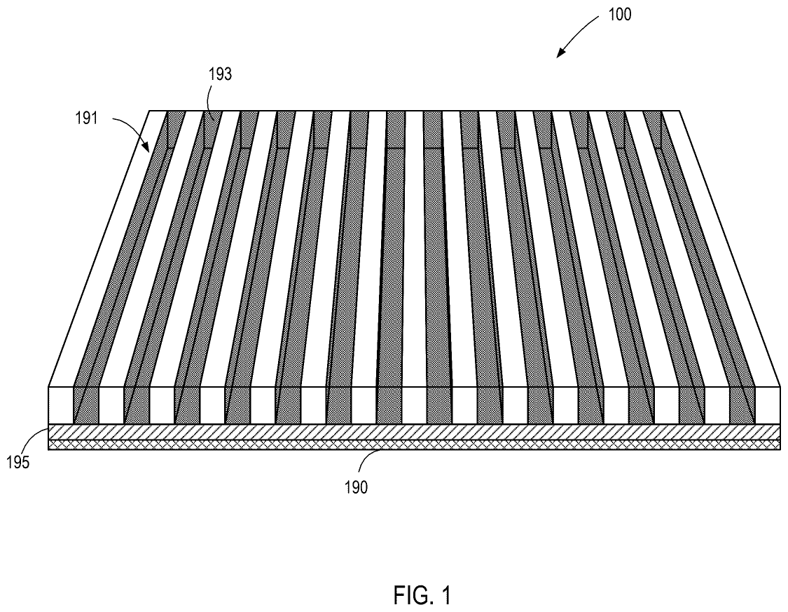

FIG. 1 illustrates an example of a metasurface 100 that is steerable in one dimension, according to various embodiments. The tunable metasurface 100 can, for example, be used as part of a solid-state optical transmitter subsystem, receiver subsystem, or transceiver system of a software-defined lidar device. As illustrated, the tunable metasurface 100 includes an optically reflective substrate 190 and a dielectric layer 195. A plurality of elongated rails 191 may be arranged at sub-wavelength intervals on the optically reflective substrate 190. Liquid crystal or another refractive index tunable dielectric material 193 may be positioned between the elongated rails 191, as described in the context of the various metasurfaces described in the references incorporated herein by reference. The metasurface 100 can be used for beam steering in one direction, such that incident optical radiation can be selectively steered at various steering angles (e.g., as scan lines steered along a single axis).

The reflection phase of the elongated rails 191 is sensitive to the refractive index of the core material, which phase modulation of 2π or nearly 2π using an index modulation of Δn/n of about 7%. The high sensitivity to the refractive index of the core material is enabled by the high Q of the resonance, for example, a Q of 20. The high sensitivity of the reflection phase to the refractive index of the core enables the integration of refractive index tunable core material into the gaps between the metal elements to create dynamic metasurfaces.

High Q factor, low-loss, subwavelength resonators can be used to allow for smaller refractive index modulation ranges of the tunable dielectric materials. The Q factor is a dimensionless parameter that characterizes a resonator's bandwidth relative to its center frequency. A high Q factor indicates a lower rate of energy loss relative to the stored energy of the resonator. Resonators with high Q factors have low damping. The optically reflective substrate 190 may be built upon underlying layers, such as a wafer substrate and layers for wires, routing, vias, capacitors, control devices, transistors, driver elements, etc., as described in the patent applications incorporated herein by reference.

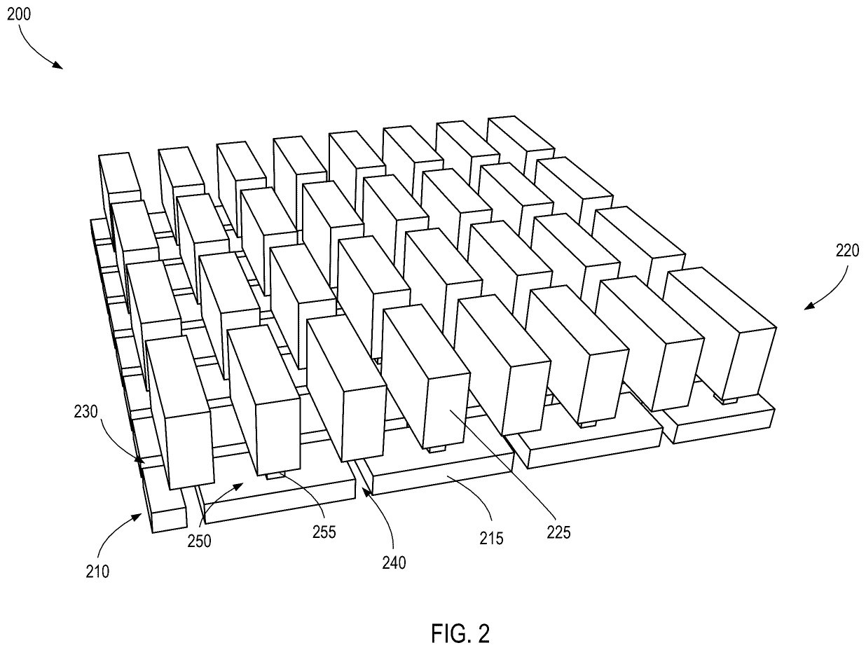

FIG. 2 illustrates a perspective view of a simplified block diagram of a reflective layer 210 and resonator layer 220 of a two-dimensional optical metasurface 200, according to one embodiment. As illustrated, the resonator layer 220 includes a two-dimensional array of metallic optical pillars 225 arranged in parallel rows. Each pillar 225 in the resonator layer 220 extends vertically relative to an underlying substrate layer (not shown) and is shaped as a rectangular prism (e.g., a rectangular cuboid). The pillars 225 in each row may be spaced from one another by less than a smallest wavelength in an operational bandwidth. The width (W) of each pillar 225 along each row may be less than one-half of the smallest wavelength of the operational bandwidth. The length (L) of each pillar 225 in a direction perpendicular to each row (e.g., along the columns) may be less than the smallest wavelength of the operational bandwidth.

The gaps between adjacent pillars 225 in each row of pillars form optical resonators. A tunable dielectric material may be deposited within the resonator layer to fill the spaces between the pillars 225 in all directions, such that tunable dielectric material is positioned within the optical resonators formed by the gaps between row-adjacent pillars 225. Examples of suitable tunable dielectric materials that have tunable refractive indices include liquid crystals, electro-optic polymer, electro-optical crystals, chalcogenide glasses, and/or various semiconductor materials.

In alternative embodiments, the pillars 225 in each row may be spaced from one another by more than a wavelength in an operational bandwidth (e.g., ten times the largest wavelength in the operational bandwidth). Similarly, in some embodiments, the width (W) of each pillar 225 along each row may be more than one-half of the smallest wavelength, and the length (L) of each pillar 225 in a direction perpendicular to each row (e.g., along the columns) may be many times larger than the largest wavelength of the operational bandwidth.

The reflective layer 210 includes a two-dimensional array of elongated rectangular reflector patches 215 extending lengthwise along parallel rows. That is, as illustrated, the reflector patches 215 extend lengthwise in a direction that is perpendicular with respect to the lengthwise direction of the pillars 225. An electrical isolation gap 230 separates reflector patches 215 in adjacent rows. An off-resonance gap 240 separates adjacent reflector patches 215 in the same row. The direction of the electrical isolation gap 230 is off-resonance with the incident electric field so there is no resonant coupling. The off-resonance gap 240 between adjacent reflector patches 215 is perpendicular to the incident electrical field. Accordingly, the dimension of the off-resonance gap 240 is selected to minimize or avoid any possible resonance between reflector patches 215 in the same row, for a range of optical radiation wavelengths. The off-resonance gap 240 may be a different size than the electrical isolation gap 230.

A dielectric via layer 250 may be positioned between the reflective layer 210 and the resonator layer 220. Each pillar 225 may be electrically connected to one underlying reflector patch 215 by a conductor via 255 within the dielectric via layer 250. The dielectric of the dielectric via layer 250 has been removed from the figure for clarity to show the positioning of the conductor vias 255. Additional examples and details related to two-dimensional tunable optical metasurfaces are described in U.S. Pat. No. 11,846,865 titled “Two-dimensional Metasurface Beam Forming Systems and Methods,” granted on Dec. 19, 2023, which application is incorporated herein by reference in its entirety.

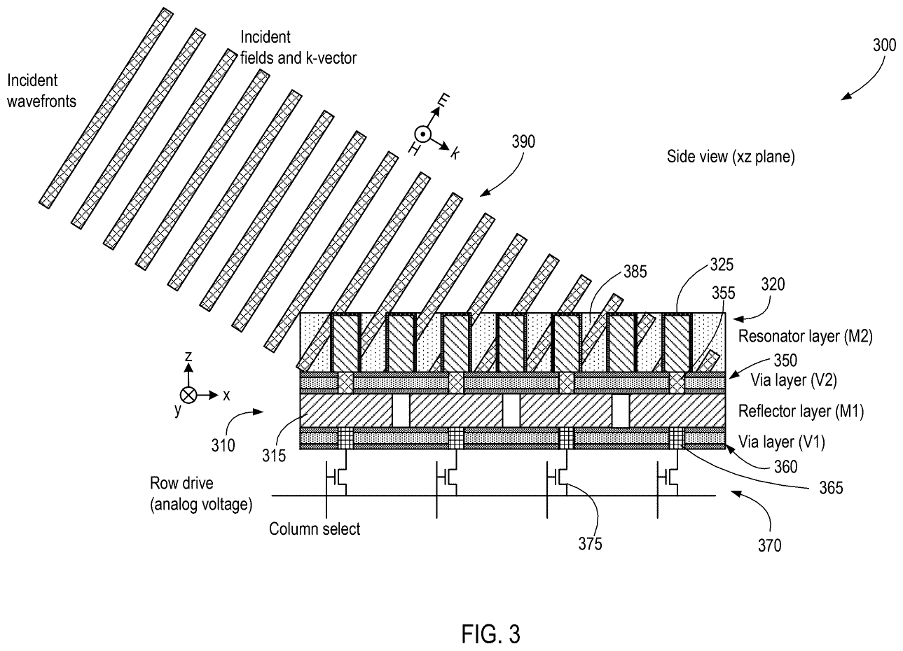

FIG. 3 illustrates a side-view diagram of the layers of a portion of a tunable optical metasurface 300 with active-matrix addressing, according to one embodiment. In the illustrated cross-sectional view, a single row of optical resonators is formed by the metallic optical pillars 325 in the resonator layer 320. The pillars 325 extend vertically relative to a substrate layer (not shown) and lengthwise into the page. A dielectric via layer 350 includes conductor vias 355 that connect the pillars 325 to reflector patches 315 within a reflective layer 310. As illustrated, the reflector patches 315 are staggered or offset with respect to one another such that the reflector patches 315 for every other pillar 325 are not visible in the cross-sectional view. The illustrated example includes a second via layer 360 with conductor vias 365 to connect the pillars 325 to the control lines and transistors 375 within the control layer 370.

The active matrix architecture enables the resonant unit cells of the metasurface 300 to exhibit a unique pattern of phase responses (Φ) as a function of the row drive (x) and the column select (y), expressible as Φ=f(x,y). The incident fields and k-vector of the wavefront of the optical radiation 390 are depicted. The metasurface 300 may be used for arbitrary phase modulation of the incident optical radiation 390 for beam steering, lensing, or another optical functionality.

As illustrated, the active matrix addressing scheme includes a transistor 375 beneath each resonant unit cell. In some embodiments, each resonant unit cell includes only a single transistor connected to one of the pillars, with the other pillar connected to a fixed voltage. In other embodiments, each resonant unit cell includes two transistors, with one transistor connected to each metallic optical pillar so that each metallic optical pillar can be driven with a unique voltage. While an absolute voltage is applied to each metallic optical pillar, the phase of each resonant unit cell depends on the voltage difference between adjacent metallic optical pillars.

According to various embodiments, the dielectric via layer 350 also functions as a waveguide layer in between the resonator layer 320 and the reflector layer 310. The thickness of the waveguide layer is such that destructive interference of the fields is created at the bottom of the optical resonator (e.g., the gap between row-adjacent optical metallic pillars), thus confining most of the optical energy to the vertical pillars with minimal leaking into the waveguide layer.

The resonant unit cells are tuned via the refractive-index tunable material 385 between adjacent metallic optical pillars 325. For example, liquid crystal, which has a high refractive index tuning range, may be used. As described herein, a differential voltage is applied between adjacent metallic optical pillars 325, which rotates the liquid crystals in that resonant unit cell, changing the refractive index experienced by the x component of the optical electric field. This consequently changes the effective length of the metallic optical pillars 325, and hence the phase experienced by the incident optical radiation 390 at that location on the metasurface. Since the resonant unit cells are resonant, changes in the phase are coupled to changes in the amplitude response in many embodiments, as is typical of Lorentz-type resonators. In such embodiments, each metallic optical pillar 325 is programmed with a unique voltage (hence phase) such that a desired spatial phase gradient is achieved. This gradient can be used for beam steering or other optical functionality such as focusing, collimating, or any arbitrary optical transformation.

Again, the metallic optical pillars 325 can be implemented in conventional CMOS manufacturing processes, such as those based on copper damascene metallization, deposition processes, etching processes, lithography processes, patterning processes, chemical mechanical planarization processes, and the like. Other metals besides copper, such as aluminum, silver, and gold, can also be used to form the metal core of each metallic optical pillar. Copper is used in many embodiments because it is widely used in the semiconductor industry to make transistors and interconnects with the dimensions required to implement the resonant unit cells described herein. In addition, copper has excellent optical properties in bandwidths encompassing near-IR and short-wave IR wavelengths.

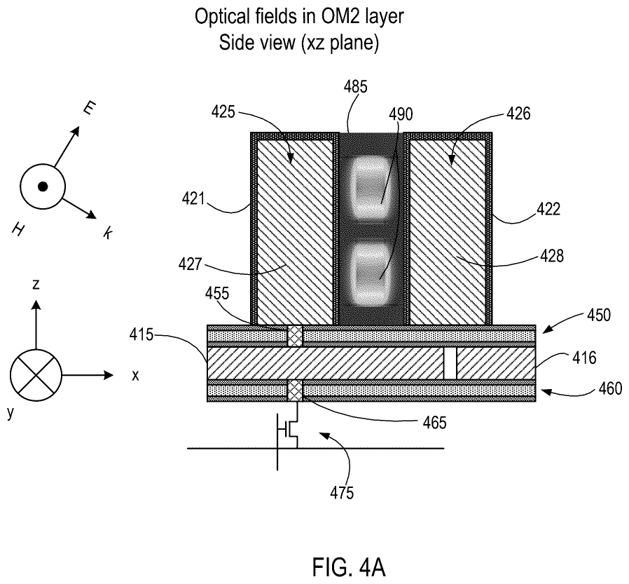

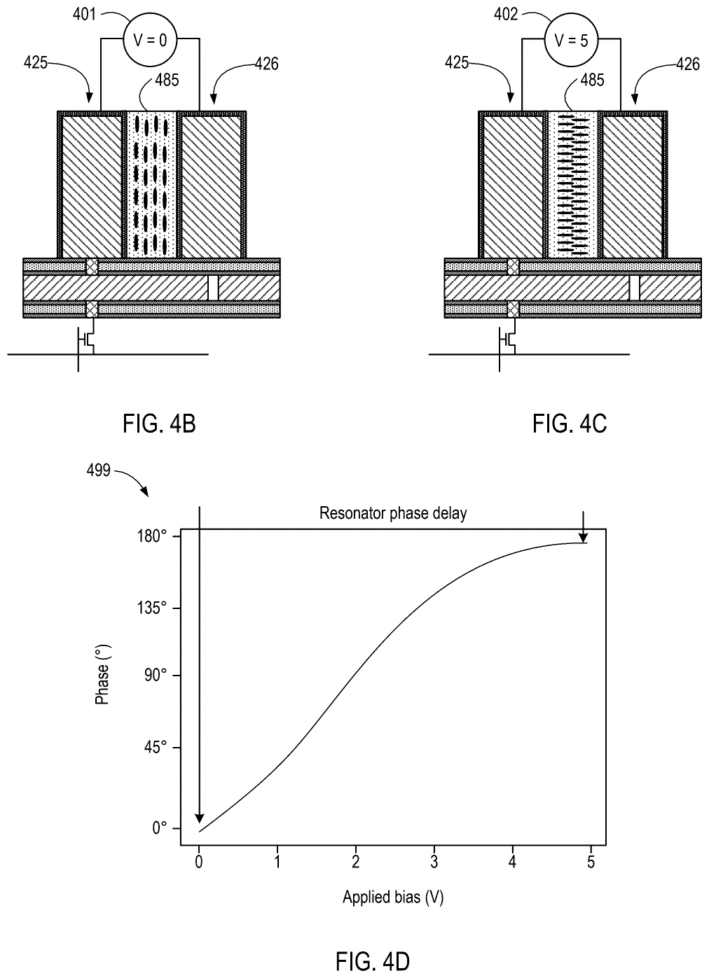

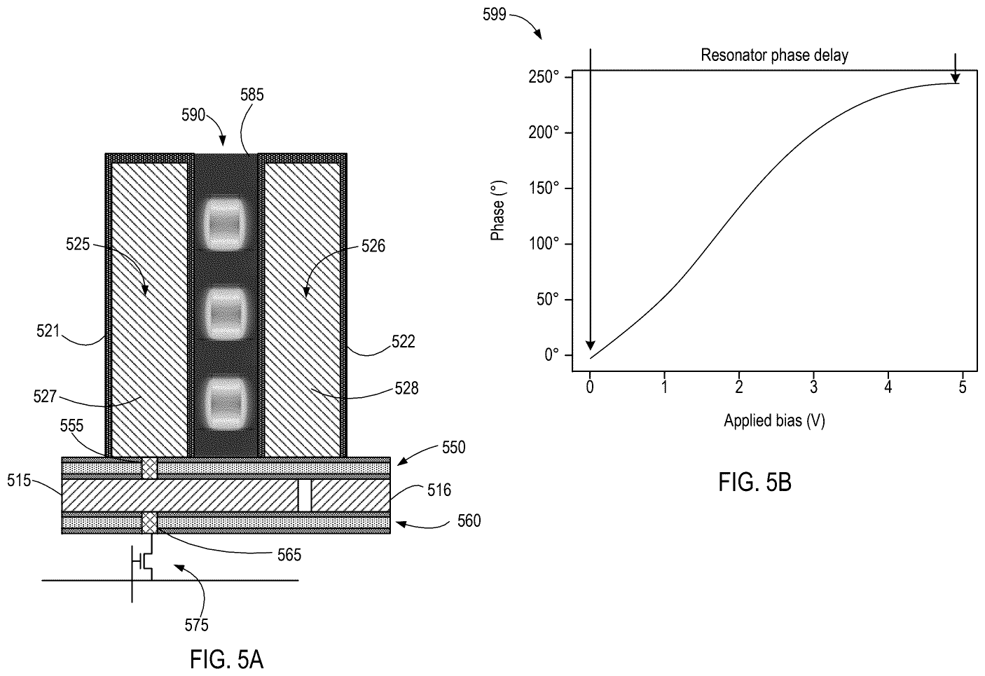

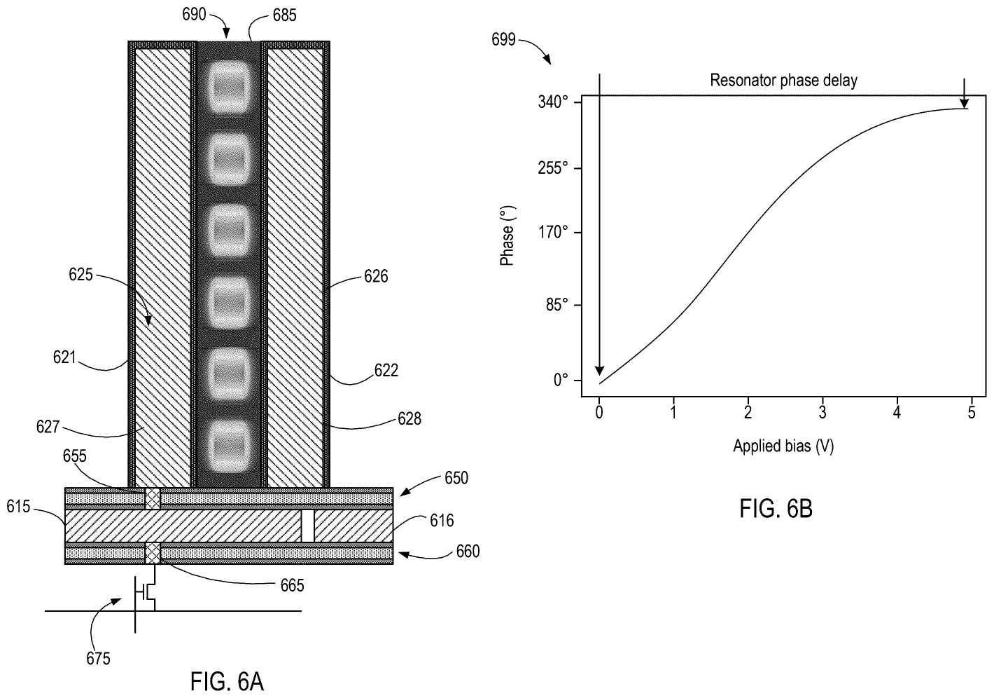

FIG. 4A illustrates an example diagram of two anti-nodes 490 of the optical field within the tunable dielectric material 485 in the gap between a pair of metallic optical pillars 425 and 426 forming an optical resonator, with underlying reflector patches 415 and 416. In the illustrated example, the heights of the metallic optical pillars 425 and 426 are selected for second-order resonance with two magnetic field anti-nodes 490. For example, a ratio of the height to the width of each metallic optical pillar 425 and 426 for second-order resonance may be approximately 2.5:1 (or, alternatively, between approximately 2:1 and 3:1). According to various embodiments, and as illustrated, each metallic optical pillar 425 and 426 includes a metal core 427 and 428 and a passivation coating 421 and 422.

The exact dimensions of the metallic optical pillars 425 and 426 may be selected based on the operational wavelength of the system. For example, the width of the gap between the metallic optical pillars 425 and 426 may be between 50 nanometers and 300 nanometers, depending on the operational wavelengths (e.g., frequency or frequency band). In various embodiments, the width of each metallic optical pillar 425 and 426 is between 75 nanometers and 200 nanometers. Accordingly, the width of the optical resonator, or pitch of the device, defined as the width of the two metallic optical pillars 425 and 426 and the width of the gap therebetween, may be between approximately 200 nanometers and 700 nanometers. To attain a 2.5:1 height-to-width aspect ratio, each metallic optical pillar 425 and 426 may have a height between approximately 187 nanometers and 500 nanometers, depending on the width of the metallic optical pillar.

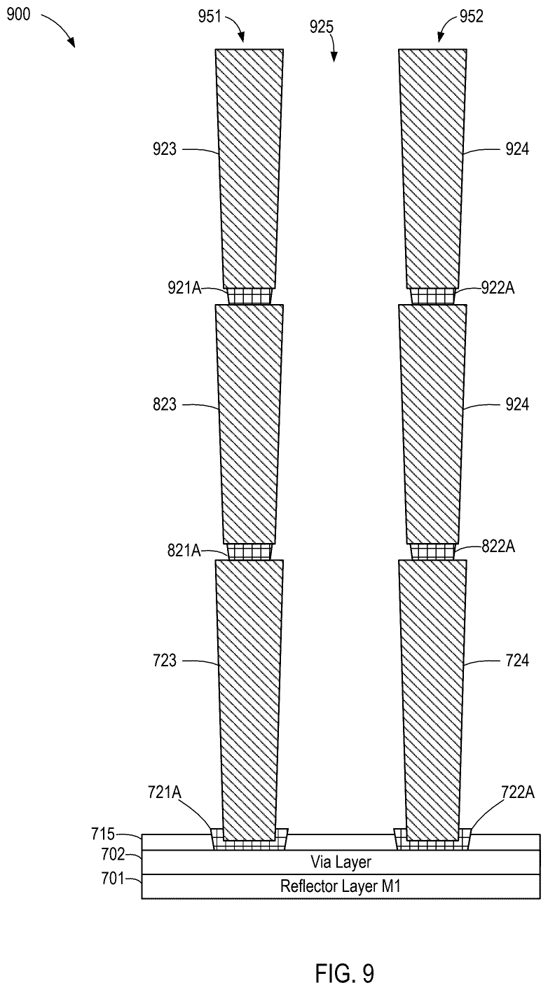

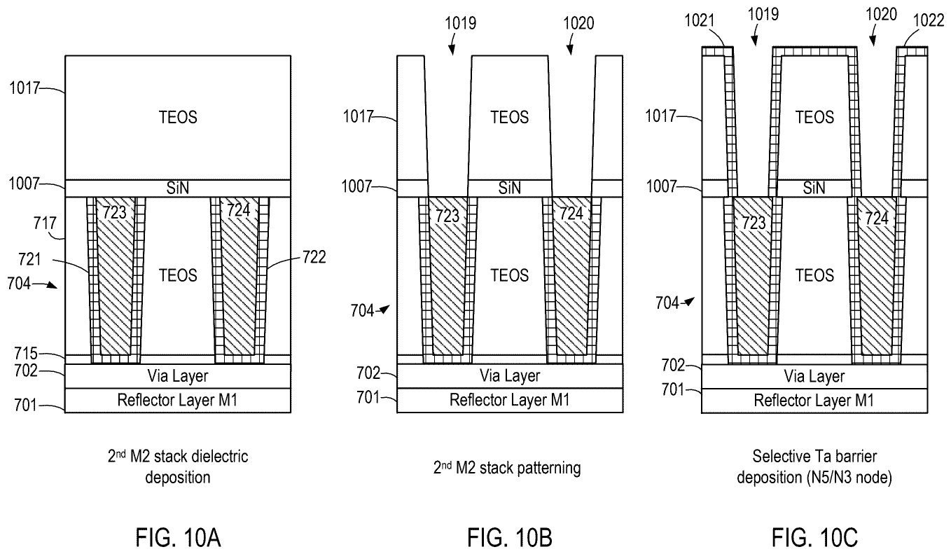

As described in the patent applications incorporated herein by reference, a two-dimensional array of metallic optical pillars may include metallic optical pillars that have rectangular cross sections, oval cross sections, polygonal cross sections, and/or other non-regular shapes. The pitch in one dimension of the metasurface may be different than the pitch in the other dimension of the metasurface. For example, in embodiments in which the resonator layer includes rectangular metallic optical pillars, the pitch in one dimension may be 500 nanometers, while the pitch in the other dimension may be 1000 nanometers (see, e.g., FIG. 7A of U.S. Pat. No. 11,960,155).

The passivation coating 421 and 422 may be deposited as a single or uniform layer that covers the sidewalls and top wall of each metallic optical pillar 425. The passivation coating 421 and 422 may be, for example, a thin silicon nitride (SiN) layer to passivate a metal core 427 and 428 of each metallic optical pillar 425. The passivation coating 421 and 422 may operate to prevent diffusion of the metal of the metallic optical pillars 425 and 426 from diffusing into the tunable dielectric material (e.g., liquid crystal) and/or prevent corrosion of the metallic optical pillars 425 and 426. The passivating coating 421 and 422 may be SiN, SiCN, aluminum oxide, or another suitable passivation material.

The passivation coating 421 and 422 may be optically transparent for wavelengths within the operational bandwidth of the metasurface and/or reflective to complement the underlying reflective conductive metal core 427 and 428 (e.g., copper). The passivation coating 421 and 422 may alternatively (or additionally) include silicon carbide nitride, silicon carbide, aluminum oxide (AlOₓ), hafnium oxide (HfO₂, silicon oxide (SiO₂), aluminum nitride (AlN), boron nitride (BN), and/or another passivating dielectric material. A transistor 475 within a control layer is connected to the pillar 425 via the reflector patch 415 and the intervening conductor vias 455 and 465 within the dielectric via layers 450 and 460. A controller can drive the pillar 425 to a target voltage via the transistor 475 to create a voltage differential within the optical resonator formed by the gap between pillars 425 and 426. The refractive index of the tunable dielectric material 485 may be adjusted to a target refractive index based on the applied voltage differential between the pillars 425 and 426.

FIG. 4B illustrates the tunable dielectric material 485 between two pillars 425 and 426 aligned in a first direction to provide a first refractive index within the optical resonator without any applied voltage (e.g., zero-volt differential, at 401), according to one embodiment.

FIG. 4C illustrates the tunable dielectric material 485 between the pillars 425 and 426 aligned in a second direction to provide a second refractive index within the optical resonator with an applied voltage of 5 volts, at 402, according to one embodiment.

FIG. 4D illustrates a graph 499 of a phase response of the optical resonator (resonant unit cell) with respect to applied voltage values, according to one embodiment. It is appreciated that the phase response and range of voltages may vary based on the specific dimensions of the pillars 425 and 426, the width of the gap forming the optical resonator that is filled with the tunable dielectric material 485, and/or the specific material (e.g., liquid crystal) used as the tunable dielectric material 485. In the illustrated example, the second-order resonance with two magnetic field anti-nodes allows for a phase response of approximately 180 degrees.

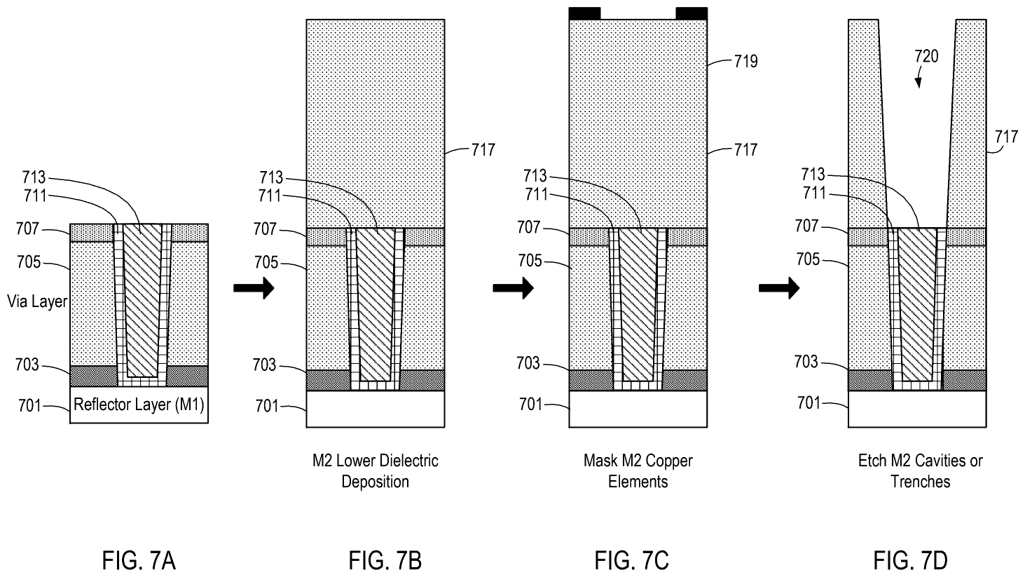

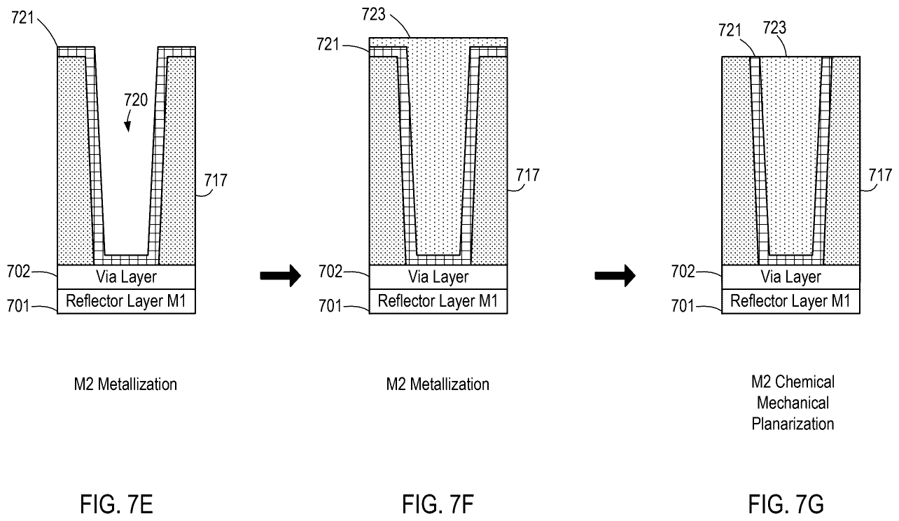

FIG. 5A illustrates an example diagram of three anti-nodes 590 of an optical field in an optical resonator with a relatively high aspect ratio, according to one embodiment. As illustrated, a tunable dielectric material 585 is positioned within the gap between a pair of metallic optical pillars 525 and 526 forming an optical resonator, with underlying reflector patches 515 and 516. In the illustrated example, the heights of the metallic optical pillars 525 and 526 are selected for third-order resonance with three magnetic field anti-nodes 590.

The ratio of the height to the width of each metallic optical pillar 525 and 526 for third-order resonance may be approximately 4:1. With a width between approximately 75 nanometers and 200 nanometers, the height of each metallic optical pillar 525 and 526 may be between approximately 300 nanometers and 800 nanometers. Again, the specific dimensions and the width of the gap between the metallic optical pillars 525 and 526 are based on the specific operational wavelength of the device (e.g., the center wavelength of an operational bandwidth of the device).

As illustrated, each metallic optical pillar 525 and 526 includes a metal core 527 and 528 and a passivation coating 521 and 522. A transistor 575 within a control layer is connected to the metallic optical pillar 525 via the reflector patch 515 and the intervening conductor vias 555 and 565 within the dielectric via layers 550 and 560. A controller can drive the metallic optical pillar 525 to a target voltage via the transistor 575 to create a voltage differential within the optical resonator formed by the gap between the metallic optical pillars 525 and 526. The refractive index of the tunable dielectric material 585 may be adjusted to a target refractive index based on the applied voltage differential between the metallic optical pillars 525 and 526.

FIG. 5B illustrates a graph 599 of a phase response of the optical resonator of FIG. 5A with respect to applied voltage values, according to one embodiment. Again, it is appreciated that the phase response and range of voltages may vary based on the specific dimensions of the pillars 525 and 526, the width of the gap forming the optical resonator that is filled with the tunable dielectric material 585, and/or the specific material (e.g., liquid crystal) used as the tunable dielectric material 585. Assuming all other variables are held constant with respect to the embodiment described in conjunction with FIGS. 4A-4D, the optical resonator with third-order resonance and three magnetic field anti-nodes allows for a phase response of approximately 250 degrees.

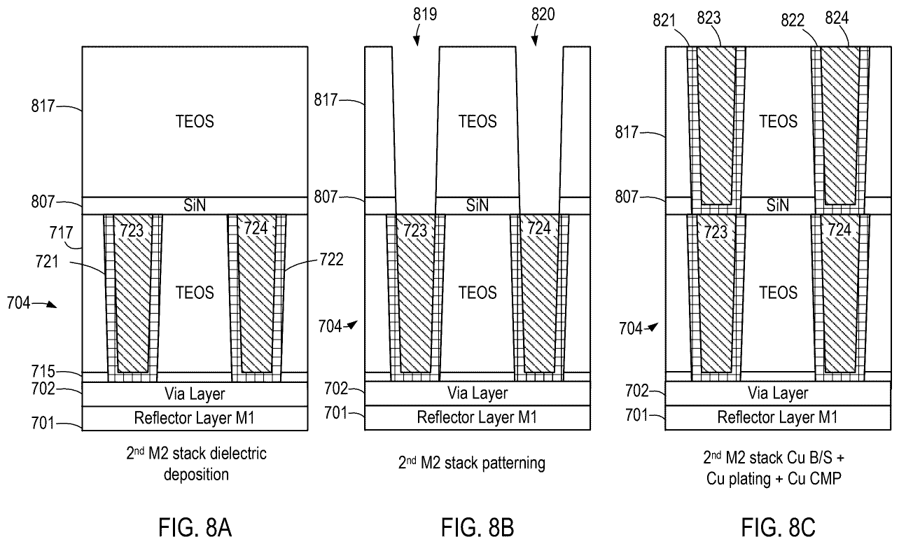

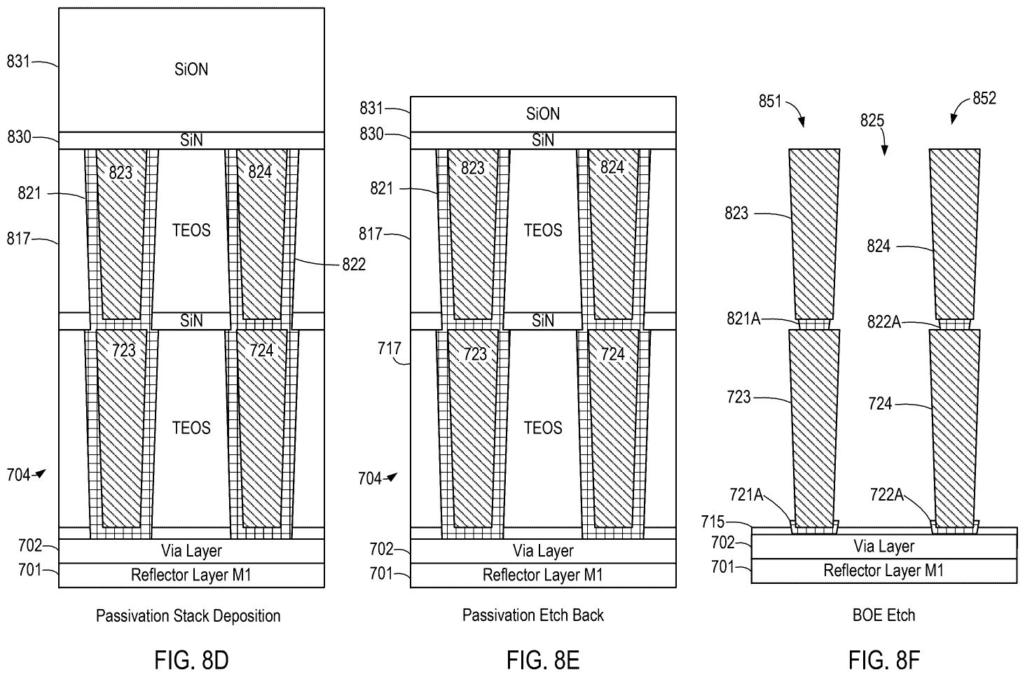

FIG. 6A illustrates an example diagram of six anti-nodes 690 of an optical field in an optical resonator with an even higher aspect ratio, according to one embodiment. A tunable dielectric material 685 is positioned within the gap between a pair of metallic optical pillars 625 and 626 forming an optical resonator, with underlying reflector patches 615 and 616. In the illustrated example, the heights of the metallic optical pillars 625 and 626 are selected for sixth-order resonance with six magnetic field anti-nodes 690 within the high-aspect-ratio channel or gap between the metallic optical pillars 625 and 626.

The ratio of the height to the width of each metallic optical pillar 625 and 626 for six-order resonance may be, for example, between approximately 7:1 and 8:1. Using metallic optical pillars 625 and 626 having widths of approximately 75-200 nanometers, the height of each metallic optical pillar 625 and 626 may be between approximately 525 nanometers and 1,600 nanometers. Again, the specific dimensions and the width of the gap between the metallic optical pillars 625 and 626 are based on the specific operational wavelength of the device (e.g., the center wavelength of an operational bandwidth of the device).

As previously described, each metallic optical pillar 625 and 626 may include a metal core 627 and 628 and a passivation coating 621 and 622. A transistor 675 within a control layer may be connected to the metallic optical pillar 625 via the reflector patch 615 and the intervening conductor vias 655 and 665 within the dielectric via layers 650 and 660. A controller can drive the metallic optical pillar 625 to a target voltage via the transistor 675 to create a voltage differential within the optical resonator formed by the gap between the metallic optical pillars 625 and 626. The refractive index of the tunable dielectric material 685 may be adjusted to a target refractive index based on the applied voltage differential between the metallic optical pillars 625 and 626. Alternative driver schemas and configurations and/or alternative reflective layer layouts may be utilized.

FIG. 6B illustrates a graph 699 of a phase response of the optical resonator of FIG. 6A with respect to applied voltage values, according to one embodiment. It is appreciated that the phase response and range of voltages may vary based on the specific dimensions of the pillars 625 and 626, the width of the gap forming the optical resonator that is filled with the tunable dielectric material 685, and/or the specific material (e.g., liquid crystal) used as the tunable dielectric material 685. Assuming all other variables are held constant with respect to the embodiment described in conjunction with FIGS. 4A-4D and FIGS. 5A-5B, the optical resonator with sixth-order resonance and six magnetic field anti-nodes allows for a phase response of approximately 340 degrees.

FIG. 7A illustrates a metallic via 713 within the a via or interconnect layer that connect a reflector of the reflector layer 701 (M1) to a metallic optical element of the optical resonator layer (M2), according to one embodiment. The metallic via 713 may be, for example, formed using the process described in U.S. patent application Ser. No. 18/423,218 filed on Jan. 25, 2024, titled “Metasurface Devices and Manufacturing Using Sequential Single-Damascene Processes with Protective Dielectric Cap Layers,” which application is hereby incorporated by reference in its entirety. As described herein and in the related applications incorporated herein by reference, any number of other layers may be positioned between a substrate layer and the reflector layer 701. The reflector layer 701 may be embodied as, for example, a planar reflector layer with vias formed therein, a crisscross pattern of reflector strips with gaps therebetween to serve as vias, and/or as a plurality of reflector patches. For instance, the reflector layer 701 may include metallic reflector patches positioned within or between dielectric layers.

In addition to the metallic via 713, the via layer may include an etch-stop layer 703, a dielectric mid-layer 705, and a dielectric cap layer 707. The metallic via 713 (e.g., copper) may be separated from dielectric layers (e.g., etch-stop layer 703, dielectric mid-layer 705, and dielectric cap layer 707) by a metallic barrier 711, as described in the applications incorporated herein by reference. The first metallic barrier 711 may comprise, for example, one or more of tantalum (Ta), tantalum nitride (TaN), and titanium nitride (TIN). The etch-stop layer 703 may be, for example, silicon nitride. The dielectric mid-layer 705 may be, for example, tetraethyl orthosilicate (TEOS) or another dielectric material. The selection of the specific material utilized for the dielectric mid-layer 705 may depend on or be selected together with a compatible etching technique (e.g., a buffered oxide etchant (BOE)).

The material for the dielectric cap layer 707 is selected to be resistant to the etching approach used in the subsequent single-damascene process used to form the stack-integrated optical resonators, as detailed herein. For example, the dielectric cap layer 707 may be an etch-resistant NBLOK® or BLOK® material available from Applied Sciences, Inc. The dielectric cap layer 707 may be a silicon carbide layer, alumina (Al₂O₃), a silicon nitride layer, a nitrogen-doped silicon carbide (NDC) layer, such as a layer, a silicon carbide deposited using plasma-enhanced chemical vapor deposition (PECVD) of trimethylsilane, and/or the like.

FIGS. 7B-7G illustrate block diagrams of a single-damascene process to form a base metallic optical element of a stack-integrated optical resonator, according to one embodiment. The single-damascene process used to form the base metallic optical element includes patterning steps, metallization (e.g., copper), and planarization (e.g., chemical mechanical planarization or “CMP”). The metallization may include a barrier deposition (e.g., tantalum), a seed deposition of the primary metal (e.g., copper), and electroplating of the primary metal (e.g., copper). The ratio of the height to the width of the base metallic optical element is referred to as the aspect ratio. The difficulty in manufacturing defect-free and/or void-free devices increases as the aspect ratio increases. For example, a single-damascene process may be limited to aspect ratios less than approximately 4:1. While aspect ratios greater than 4:1 might be achieved, the quality of the barrier/seed step may experience coverage issues, voids may be formed, and/or other defects may arise. Higher aspect ratio devices (e.g., 4:1, 6:1, 8:1, 10:1, etc.) may be desirable in some applications to increase optical efficiency (e.g., via higher-order resonance) and/or reduced sidelobe transmission at various steering angles, steering directions, and/or beamform shapes.

FIG. 7B illustrates the deposition of a resonator dielectric layer 717 to be etched to form a metallic optical element of an optical resonator in the resonator layer. The resonator dielectric layer 717 may be, for example, tetraethyl orthosilicate (TEOS) or another dielectric material suitable for etching. The selection of the specific material utilized for the resonator dielectric layer 717 may depend on or be selected together with a compatible etching technique (e.g., a buffered oxide etchant (BOE)).

FIG. 7C illustrates a resonator mask layer 719 added to control the etching of the resonator dielectric layer 717 down to the dielectric cap layer 707 (in some embodiments, a separate resonator etch-stop layer may be included as a layer above the dielectric cap layer 707, as detailed in the patent applications incorporated herein by reference.

FIG. 7D illustrates a cavity or channel 720 etched into the resonator dielectric layer 717 that stops after the dielectric cap layer 707 to expose the surface of the metallic via 713. The resonator mask layer 719 is removed after the etching is completed. In some embodiments, the etching process may include two or more stages that utilize different etching techniques. For example, a BOE wet etch may be used to etch down to a resonator etch-stop layer (not shown), after which a more precise or controlled etching technique may be used to carefully remove the resonator etch-stop layer (not shown) without damaging the underlying metallic via 713, the first metallic barrier 711, and/or the dielectric cap layer 707.

The dielectric cap layer 707 prevents the resonator etch step of the single-damascene process from destroying or otherwise damaging the dielectric material within the interconnect layer (via layer) or undercutting the sidewalls of the cavity or channel 720. Moreover, the dielectric cap layer 707 operates to ensure that the shape of the already-formed metallic via 713 and the shape of the soon-to-be-formed metallic optical element are well-defined.

FIG. 7E illustrates a metallic barrier 721 deposited on the sidewalls and base of the cavity or channel 720. The metallic barrier 721 operates to, for example, prevent diffusion of the metal used to form the bulk of the metallic optical elements into the dielectric materials and/or to prevent corrosion of the optical elements. The metallic barrier 721 may comprise, for example, one or more of tantalum (Ta), tantalum nitride (TaN), and titanium nitride (TIN). To avoid obscuring aspects of FIG. 7E and the subsequent drawings, the via layer 702 is hereafter shown in a simplified format, similar to the format used to represent the reflector layer 701.

FIG. 7F illustrates the bulk metal deposited within the cavity or channel 720 to form the metallic optical element 723. The process may include, for example, a metal seed deposition followed by electroplating. The seed deposition may include, for example, a sputtering process and/or a vapor deposition process.

FIG. 7G illustrates the use of chemical mechanical planarization (CMP) to finalize the formation of the metallic optical element 723 and remove the metallic barrier 721 that is outside of the cavity or channel 720. The metallic optical element 723 formed via the illustrated single-damascene process may have an aspect ratio of between approximately 2:1 and 4:1 (illustrated as approximately 2.5:1). In various embodiments, this aspect ratio may be suitable for second-order resonance for a given operational wavelength. For applications in which the low aspect ratio or medium aspect ratio elements are suitable, the resonator dielectric layer 717 and the metallic barrier 721 on the sidewalls of the metallic optical element 723 may be removed (e.g., etched) to expose the base metallic optical element 723. However, in applications in which a stack-integrated metallic optical element with a higher aspect ratio is desired, additional stacked metallic optical elements may be formed prior to etching, as described herein.

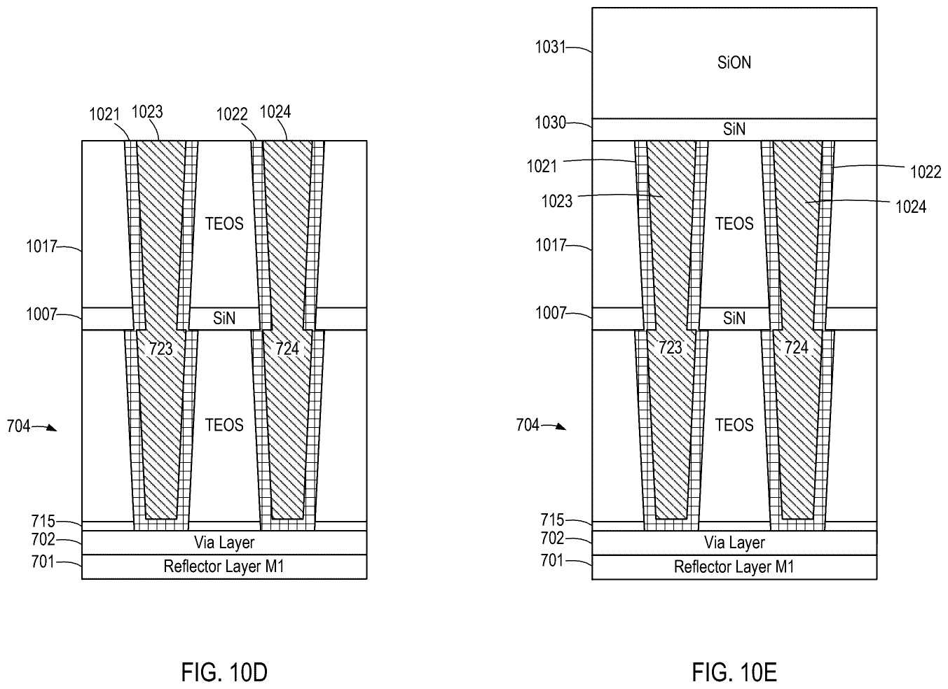

FIGS. 8A-8F illustrate a single-damascene process to form a stacked metallic optical element on the base metallic optical element with a metallic barrier connection, according to one embodiment. As detailed herein, devices can be manufactured to include stack-integrated metallic optical elements with high height-to-width aspect ratios that exceed 4:1. Various approaches are described herein to manufacture high-aspect-ratio metallic optical elements using stacked optical resonator sections, each of which is formed using a modified single damascene process. FIGS. 8A-F illustrate one example of a stacked manufacturing process for high-aspect-ratio stack-integrated metallic optical elements.

FIG. 8A illustrates a stacked dielectric cap layer 807 and a stacked resonator dielectric layer 817 deposited on top of the base metallic optical element formation 704. As illustrated, the base metallic optical element formation 704 includes base metallic optical elements 723 and 724, metallic barriers 721 and 722, a resonator dielectric layer 717, and a resonator etch-stop layer 715, as detailed and described above in conjunction with FIGS. 7A-7G.

FIG. 8B illustrates cavities 819 and 820 (or extended channels) formed in the stacked resonator dielectric layer 817 and the stacked dielectric cap layer 807. As previously described, any of a wide variety of photoresists, masking processes, curing processes, and/or etching processes may be used to form the cavities 819 and 820.

FIG. 8C illustrates metallic barriers 821 and 822 formed on the sidewalls and on the base walls of the cavities 819 and 820. Stacked metallic optical elements 823 and 824 are then formed within the cavities 819 and 820. As previously described, the stacked metallic optical elements 823 and 824 may comprise copper optical elements. The copper (or other metal) may be formed via a seed deposition step followed by electroplating (or other plating process). Any metal that overfills the cavities may be planarized via chemical mechanical planarization (CMP).

FIG. 8D illustrates the subsequent formation of additional dielectric passivation layers 830 and 831. The additional dielectric passivation layers 830 and 831 may be deposited during the passivation of bond pads or other elements of the metasurface device that are ancillary to the presently described systems and methods.

FIG. 8E illustrates the additional dielectric passivation layer 831 etched back. Again, the passivation etch back of the additional dielectric passivation layer 831 may be implemented during the formation and finalization of other portions of a metasurface, such as bond pads. As these steps are ancillary to or outside the scope of the presently described high-aspect-ratio metasurface devices formed via sequential, stacked single-damascene manufacturing processes, they are not described in greater detail herein.

FIG. 8F illustrates a gap 825 (e.g., a cavity or channel) between a first stack-integrated metallic optical element 851 and a second stack-integrated metallic optical element 852 after an etching process (e.g., a BOE etching process). In the illustrated example, the first stack-integrated metallic optical element 851 is a double-stacked metallic optical element that includes a base metallic optical element 723 and a stacked metallic optical element 823. Similarly, the second stack-integrated metallic optical element 852 is a double-stacked metallic optical element that includes a base metallic optical element 724 and a stacked metallic optical element 824.

The etching processes, as illustrated, are used to remove the additional dielectric passivation layers 830 and 831 from above the optical resonator layer of the metasurface device. The etching process, as illustrated, is also used to remove the stacked dielectric cap layer 807, the stacked resonator dielectric layer 817, and the base resonator dielectric layer 717. Notably, the etching process removes the metallic barriers 721 and 722 from the sidewalls of the base metallic optical elements 723 and 724 while leaving patches 721A and 722A thereof. The patches may be shaped similarly to that of the base of the base metallic optical elements 723 and 724 (e.g., square, rectangular, circle, oval, conic slice, trapezoidal, rectangular, elongated strip, etc.). The patches 721A and 722A of the metallic barriers 721 and 722 remain in place between the metallic optical elements 723 and 724 and the dielectric layers of the via layer 702 to prevent diffusion of the copper (or other metal(s)) of the base metallic optical elements 723 and 724. The patches 721A and 722A of the metallic barriers 721 and 722 also provide a conductive connection between the metallic vias (e.g., metallic via 713 of FIG. 7G) of the via layer 702 and the base metallic optical elements 723 and 724.

The etching process also removes the metallic barriers 821 and 822 from the sidewalls of the stacked metallic optical elements 823 and 824. Notably, metallic barrier connections 821A and 822A remain in place between the stacked metallic optical elements 823 and 824 and the base metallic optical elements 723 and 724. Specifically, the first metallic barrier connection 821A conductively connects the stacked metallic optical element 823 with the base metallic optical element 723. Similarly, the second metallic barrier connection 822A conductively connects the stacked metallic optical element 824 with the base metallic optical element 724.

According to various embodiments, and as described herein, the gap 825 may be filled with a tunable dielectric material, such as liquid crystal. In the illustrated example, the stack-integrated metallic optical elements 851 and 852 have a high aspect ratio of approximately 7.5:1. In the illustrated example, the base metallic optical elements 723 and 724 and the stacked metallic optical elements 823 and 824 are approximately the same size. In other embodiments, they may be different sizes. For example, the base metallic optical elements 723 and 724 may have an aspect ratio of 3:1, while the stacked metallic optical elements 823 and 824 may have an aspect ratio of only 2:1. In such an embodiment, the resulting stack-integrated metallic optical elements 851 and 852 would have a relatively high aspect ratio of approximately 5:1. A one-dimensional array of elongated stack-integrated metallic optical elements 851 and 852 may be used to form a metasurface that is steerable in one direction. A two-dimensional array of stack-integrated metallic optical elements 851 and 852 (e.g., pillars) may be used to form a metasurface that is steerable in multiple directions.

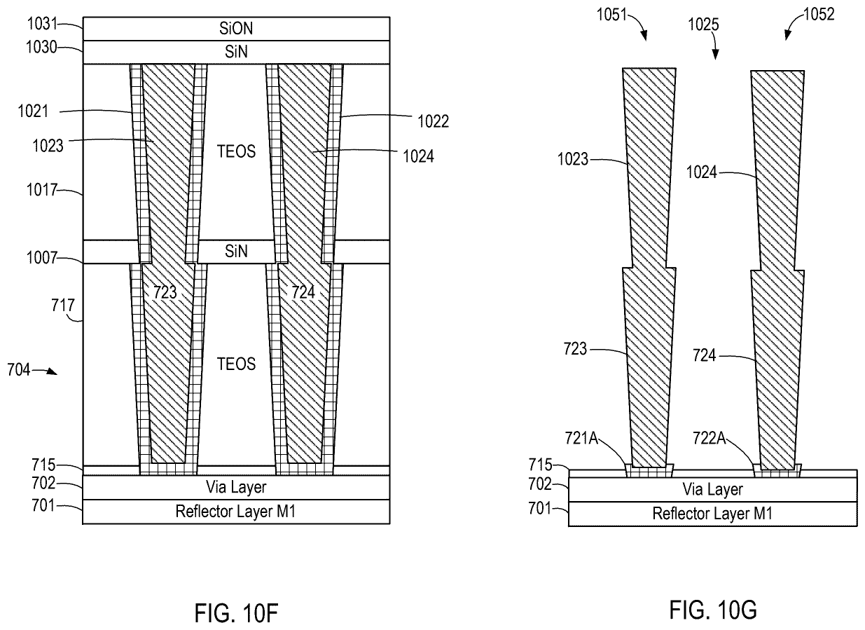

FIG. 9 illustrates an example of a high-aspect-ratio optical resonator 900 formed with stack-integrated metallic optical elements 951 and 952 and metallic barrier connections 921A, 922A, 821A, and 822A, according to one embodiment. The first stack-integrated metallic optical element 951 is physically isolated from and conductively connected to the via layer 702 by a patch 721A of the metallic barrier 721. The first stack-integrated optical element 951 includes a base metallic optical element 723, a first stacked metallic optical element 823, and a second stacked metallic optical element 923.

The second stack-integrated metallic optical element 952 includes a base metallic optical element 724, a first stacked metallic optical element 824, and a second stacked metallic optical element 924. The second stack-integrated metallic optical element 952 is physically isolated from and conductively connected to the via layer 702 by a patch 722A of the metallic barrier 722. The metallic barrier connections 921A, 922A, 821A, and 822A and the patches 721A and 722A are not necessarily drawn to scale.

A gap 925 is formed between the stack-integrated metallic optical elements 951 and 952 that can be, for example, filled with liquid crystal or another tunable dielectric material. According to various embodiments, each of the stack-integrated metallic optical elements 951 and 952 of the high-aspect-ratio optical resonator 900 may have an aspect ratio of greater than 4:1 (e.g., 9.5:1), where the height of each stack-integrated metallic optical element 951 and 952 is at least four times a maximum or average width thereof.

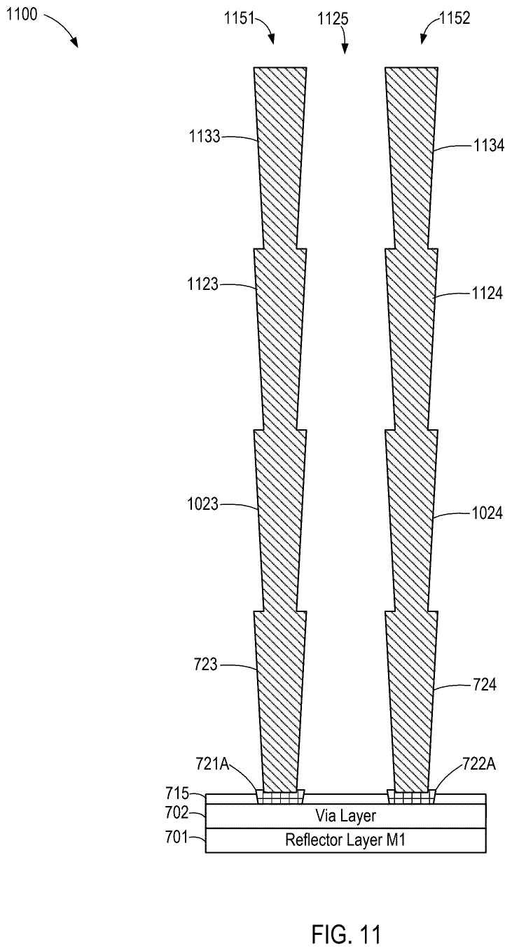

FIGS. 10A-10G illustrate another single-damascene process to form a stacked metallic optical element with a selectively deposited and removed metallic barrier, according to one embodiment.

FIG. 10A illustrates a stacked dielectric cap layer 1007 and a stacked resonator dielectric layer 1017 deposited on top of the base metallic optical element formation 704. As previously described, the base metallic optical element formation 704 includes base metallic optical elements 723 and 724, metallic barriers 721 and 722, a resonator dielectric layer 717, and a resonator etch-stop layer 715.

FIG. 10B illustrates cavities 1019 and 1020 (or extended channels) formed in the stacked resonator dielectric layer 1017 and the stacked dielectric cap layer 1007. Again, any of a wide variety of photoresists, masking processes, curing processes, and/or etching processes may be used to form the cavities 1019 and 1020.

FIG. 10C illustrates a metallic barrier 1021 and 1022 formed on the sidewalls of the cavities 1019 and 1020. As in previous embodiments, the metallic barrier 1021 and 1022 may comprise, for example, one or more of tantalum (Ta), tantalum nitride (TaN), and titanium nitride (TiN). Notably, the metallic barriers 1021 and 1022 are not deposited on the base walls of the cavities 1019 and 1020. Instead, selective barrier deposition (e.g., a selective tantalum (Ta) deposition) may be implemented to deposit the barrier material only on the sidewalls of the cavities 1019 and 1020. Such a selective barrier deposition is deposited, for example, using N5 or N3 manufacturing processes (e.g., 5 nm and 3 nm semiconductor manufacturing processes).

FIG. 10D illustrates stacked metallic optical elements 1023 and 1024 formed within the cavities 1019 and 1020. As illustrated, the metal (e.g., copper) of the stacked metallic optical elements 1023 and 1024 is directly connected to the metal (e.g., copper) of the base metallic optical elements 723 and 724, respectively. As illustrated, limitations of the manufacturing process (etching limitations) may result in tapered cavities that, when filled with copper or another metal, result in each of the metallic optical elements 723, 724, 1023, and 1024 having a tapered shape. The tapered shape allows for the base metallic optical elements 723 and 724 to be distinguished from the stacked metallic optical elements 1023 and 1024.

However, in some embodiments, etching processes may be utilized to allow for the formation of cavities with nearly straight or even perfectly straight walls. In such embodiments, the metallic optical elements (base metallic optical elements 723 and 724 and stacked metallic optical elements 1023 and 1024) may have uniform widths from top to bottom. As such, the stacked metallic optical elements 1023 and 1024 and the base metallic optical elements 723 and 724 may be uniform in width from top to bottom and homogeneous in material composition. As previously described, the stacked metallic optical elements 1023 and 1024 may comprise copper optical elements. The copper (or other metal) may be formed via a seed deposition step followed by electroplating. Any metal that overfills the cavities may be planarized via chemical mechanical planarization (CMP).

FIG. 10E illustrates the subsequent formation of additional dielectric passivation layers 1030 and 1031. Again, the additional dielectric passivation layers 1030 and 1031 may be deposited during the passivation of bond pads or other elements of the metasurface device that are ancillary to the presently described systems and methods.

FIG. 10F illustrates the additional dielectric passivation layer 1031 etched back.

FIG. 10G illustrates a gap 1025 (e.g., a cavity or channel) between a first stack-integrated metallic optical element 1051 and a second stack-integrated metallic optical element 1052 after an etching process (e.g., a BOE etching process). In the illustrated example, the first stack-integrated metallic optical element 1051 is a double-stacked metallic optical element that includes a base metallic optical element 723 and a stacked metallic optical element 1023. Similarly, the second stack-integrated metallic optical element 1052 is a double-stacked metallic optical element that includes a base metallic optical element 724 and a stacked metallic optical element 824.

The etching processes, as illustrated, are used to remove the additional dielectric passivation layers 1030 and 1031 from above the optical resonator layer of the metasurface device. The etching process, as illustrated, is also used to remove the stacked dielectric cap layer 1007, the stacked resonator dielectric layer 1017, and the base resonator dielectric layer 717. Notably, the etching process removes the metallic barrier 721 and 722 from the sidewalls of the base metallic optical elements 723 and 724 while leaving patches 721A and 722A thereof. The patches 721A and 722A of the metallic barrier 721 and 722 remains in place between the base metallic optical elements 723 and 724 and the dielectric layers of the via layer 702 to prevent diffusion of the copper (or other metal(s)) of the base metallic optical elements 723 and 724. The patches 721A and 722A of the metallic barrier 721 and 722 also provide a conductive connection between the metallic vias (e.g., metallic via 713 of FIG. 7G) of the via layer 702 and the base metallic optical elements 723 and 724.

The etching process also removes the metallic barrier 1021 and 1022 from the sidewalls of the stacked metallic optical elements 1023 and 1024. The stacked metallic optical element 1023 is only distinguishable from the base metallic optical element 723 due to the tapered formations thereof. The taper may be larger or smaller than illustrated. In embodiments, the widths of the top portion and the bottom portion of each metallic optical element (e.g., the base metallic optical element 723 or the stacked metallic optical element 1023) may be the same or substantially the same. The sidewalls may be substantially straight (as illustrated), more rounded, and/or exhibit some imperfections or non-uniformities, depending on the etching process utilized.

The gap 1025 may be filled with a tunable dielectric material, such as liquid crystal. In the illustrated example, the stack-integrated metallic optical elements 1051 and 1052 have a high aspect ratio of approximately 7:1. A one-dimensional array of elongated stack-integrated metallic optical elements 1051 and 1052 may be used to form a metasurface that is steerable in one direction. A two-dimensional array of stack-integrated metallic optical elements 1051 and 1052 (e.g., pillars) may be used to form a metasurface that is steerable in multiple directions (e.g., two directions).

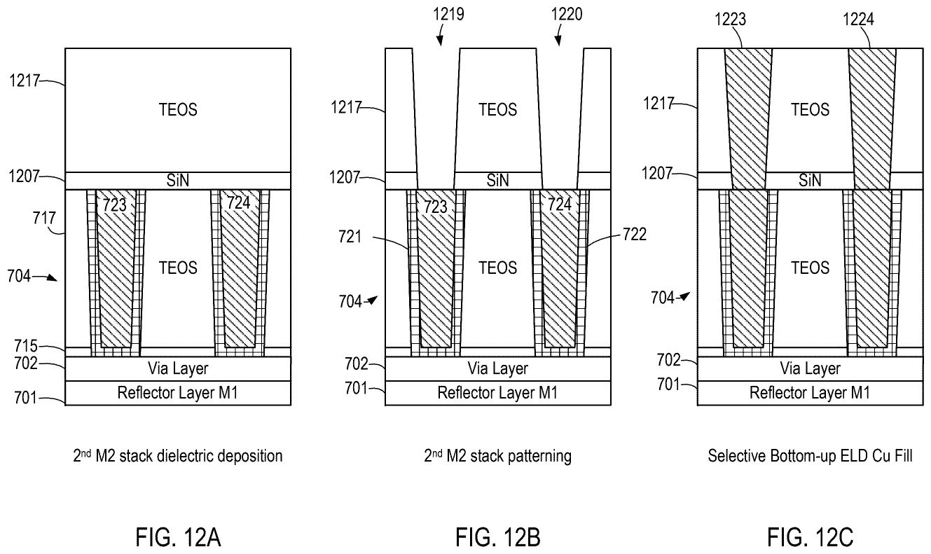

FIG. 11 illustrates an example of a high-aspect-ratio optical resonator 1100 with stack-integrated metallic optical elements 1151 and 1152, each of which is formed with four metallic optical elements without metallic barrier connections, according to one embodiment. The first stack-integrated metallic optical element 1151 is physically isolated from and conductively connected to the via layer 702 by metallic barrier patch 721A, where the metallic barrier patch 721A is a conductive barrier patch. The first stack-integrated metallic optical element 1151 includes a base metallic optical element 723, a first stacked metallic optical element 1023, a second stacked metallic optical element 1123, and a third stacked metallic optical element 1133.

The second stack-integrated metallic optical element 1152 includes a base metallic optical element 724, a first stacked metallic optical element 1024, a second stacked metallic optical element 1124, and a third stacked metallic optical element 1134. The second stack-integrated metallic optical element 1152 is physically isolated from and conductively connected to the via layer 702 by a patch 722A of the metallic barrier 722. The patches 721A and 722A of the metallic barrier connections and other layer thicknesses and relative sizes are not drawn to scale and may be much thinner (or thicker) than depicted.

A gap 1125 is formed between the stack-integrated metallic optical elements 1151 and 1152 that can be, for example, filled with liquid crystal or another tunable dielectric material. According to various embodiments, each of the stack-integrated metallic optical elements 1151 and 1152 of the high-aspect-ratio optical resonator 1100 may have an aspect ratio of greater than 4:1 (e.g., 8:1, 11:1, etc.), where the height of each stack-integrated metallic optical element 1151 and 1152 is at least four times a width thereof (e.g., four times the minimum width thereof, four times an average width thereof, or four times a maximum width thereof).

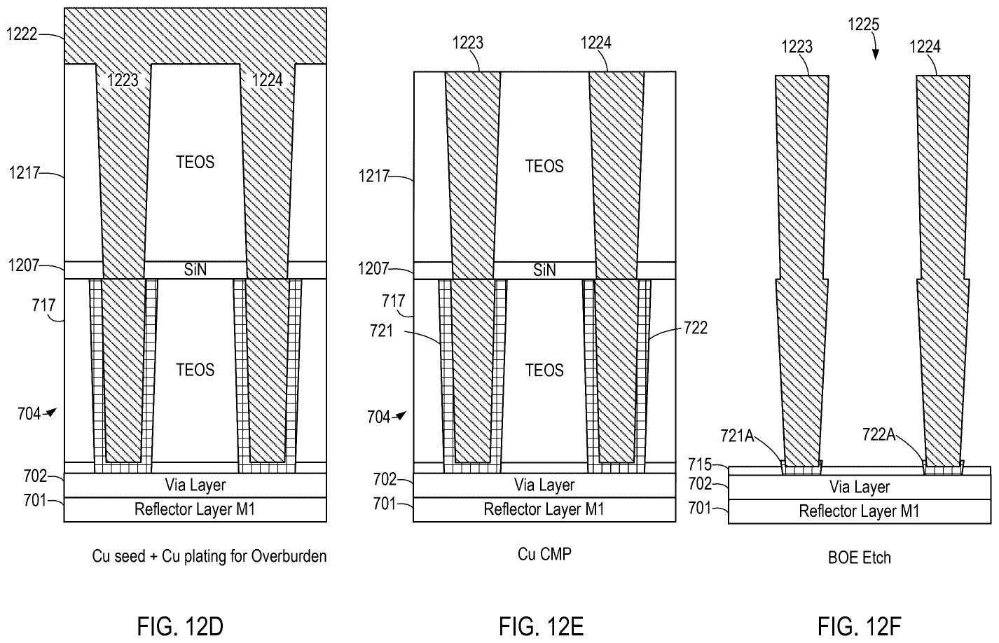

FIGS. 12A-12F illustrate another single-damascene process to form a stacked metallic optical element without a metallic barrier, according to one embodiment.

FIG. 12A illustrates a stacked dielectric cap layer 1207 and a stacked resonator dielectric layer 1217 deposited on top of the base metallic optical element formation 704. As previously described, the base metallic optical element formation 704 includes base metallic optical elements 723 and 724, metallic barriers 721 and 722, a resonator dielectric layer 717, and a resonator etch-stop layer 715.

FIG. 12B illustrates cavities 1219 and 1220 (or extended channels) formed in the stacked resonator dielectric layer 1217 and the stacked dielectric cap layer 1207. As in previous embodiments, any of a wide variety of photoresists, masking processes, curing processes, and/or etching processes may be used to form the cavities 1219 and 1220. Notably, and in contrast to the embodiments described in connection with FIGS. 8C and 10C, no metallic barrier layer is deposited on the sidewalls or base wall of the cavities 1219 and 1220.

FIG. 12C illustrates stack-integrated metallic optical elements 1223 and 1224 formed within the cavities 1219 and 1220. The metal (e.g., copper) forming the stack-integrated metallic optical elements 1223 and 1224 is deposited, for example, using a bottom-up electroless deposition (ELD) process on top of the existing base metallic optical elements 723 and 724. As illustrated, the upper portion of the metal (e.g., copper) of the stack-integrated metallic optical elements 1223 and 1224 is directly connected to the metal (e.g., copper) of the base metallic optical elements 723 and 724, respectively (see FIG. 12B). The lack of a barrier dielectric between the stack-integrated metallic optical elements 1223 and 1224 and the stacked resonator dielectric layer 1217 is not problematic because the stacked resonator dielectric layer 1217 will be etched away.

FIG. 12D illustrates an alternative approach to form stack-integrated metallic optical elements 1223 and 1224 within the cavities 1219 and 1220 via seeding and plating metallic deposition processes, resulting in a metallic overburden 1222.

FIG. 12D illustrates the stack-integrated metallic optical elements 1223 and 1224 after planarization (e.g., chemical mechanical planarization) of the metallic overburden 1222. As in other embodiments, additional dielectric passivation layers may be deposited during the passivation of bond pads or other elements of the metasurface device that are ancillary to the presently described systems and methods. These additional dielectric passivation layers may be removed (e.g., etched) from above the metallic optical elements 1223 and 1224.

FIG. 12F illustrates a gap 1225 (e.g., a cavity or channel) between a first stack-integrated metallic optical element 1223 and a second stack-integrated metallic optical element 1224 after an etching process (e.g., a BOE etching process). In the illustrated example, the first and second stack-integrated metallic optical elements 1223 and 1224 are double-stacked metallic optical elements that each include a base metallic optical element formed via a single-damascene process and a stacked metallic optical element formed via another single-damascene process. In some embodiments, the base metallic optical elements may be formed as part of a dual-damascene process together with vias in an underlying interconnect layer. The sizes and relative dimensions of the base and stacked metallic optical elements, and the lack of any metallic barrier connections, result in stack-integrated metallic optical elements 1223 and 1224 that are metallically homogeneous.

The etching processes, as illustrated, are used to remove the stacked dielectric cap layer 1207, the stacked resonator dielectric layer 1217, and the base resonator dielectric layer 717. Notably, the etching process removes most of the metallic barrier 721 and 722 but leaves patches 721A and 722A. The patches 721A and 722A of the metallic barrier 721 and 722 remain in place between the metallic optical elements and the dielectric layers in the via layer 702 to prevent diffusion of the copper (or other metal(s)). The patches 721A and 722A of the metallic barrier 721 and 722 also provide a conductive connection between the metallic vias (e.g., metallic via 713 of FIG. 7G) of the via layer 702 and the stack-integrated metallic optical elements 1223 and 1224.

The gap 1225 may be filled with a tunable dielectric material, such as liquid crystal. In the illustrated example, the stack-integrated metallic optical elements 1223 and 1224 have a high aspect ratio of approximately 7:1. A one-dimensional array of elongated stack-integrated metallic optical elements 1223 and 1224 may be used to form a metasurface that is steerable in one direction. A two-dimensional array of stack-integrated metallic optical elements 1223 and 1224 (e.g., pillars) may be used to form a metasurface that is steerable in multiple directions.

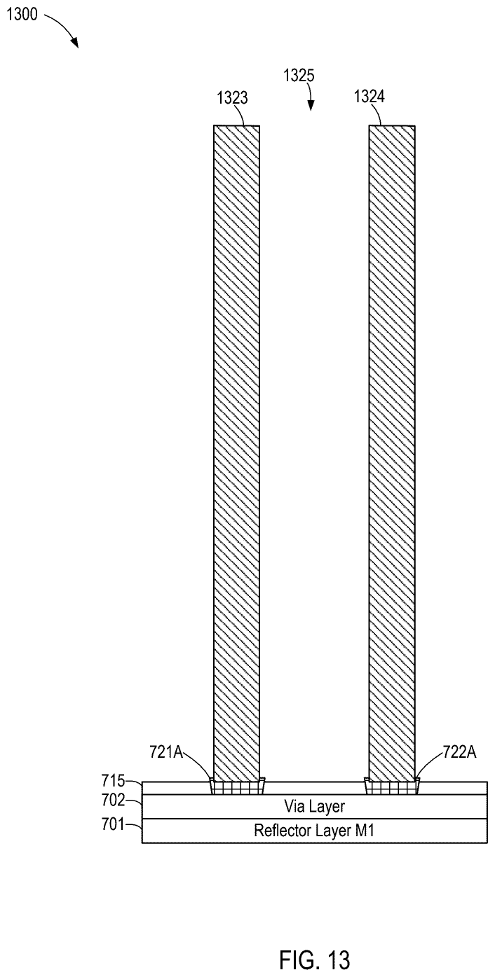

FIG. 13 illustrates an example of a high-aspect-ratio optical resonator 1300 formed with stack-integrated metallic optical elements 1323 and 1324, according to one embodiment. The first stack-integrated metallic optical element 1323 is physically isolated from and conductively connected to the via layer 702 by a patch 721A. The second stack-integrated metallic optical element 1324 is physically isolated from and conductively connected to the via layer 702 by a patch 722A.

A gap 1325 is formed between the stack-integrated metallic optical elements 1323 and 1324 that can be, for example, filled with liquid crystal or another tunable dielectric material. According to various embodiments, each of the stack-integrated metallic optical elements 1323 and 1324 of the high-aspect-ratio optical resonator 1300 may have an aspect ratio of greater than 4:1 (e.g., 8:1). Each of the stack-integrated metallic optical elements 1323 and 1324 may be formed via a sequence of single-damascene processes to form a base metallic optical element and any number of stacked optical elements, each of which may have individually had an aspect ratio of between 1:1 and 4:1.

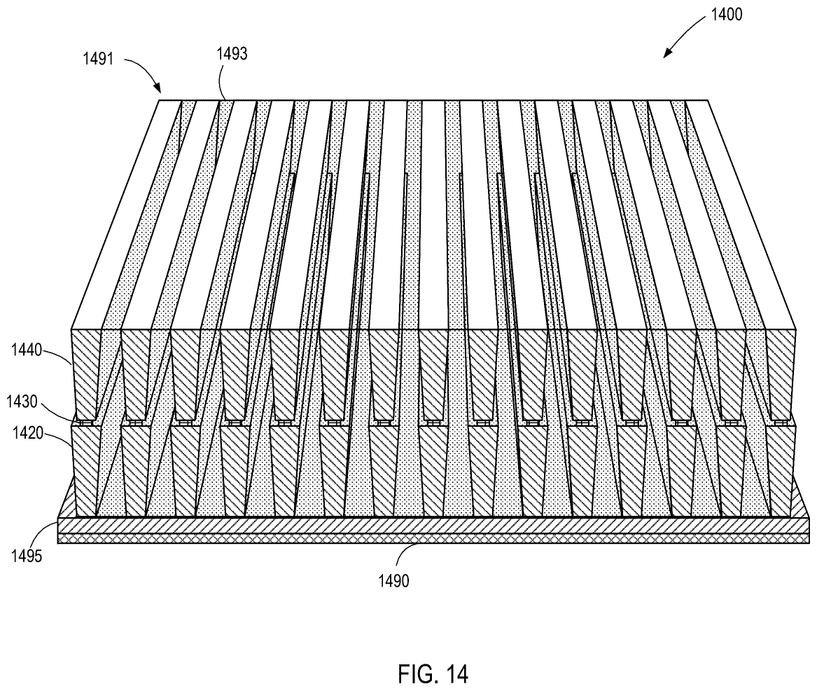

FIG. 14 illustrates a perspective view of a simplified block diagram of a tunable metasurface 1400 that is steerable in one dimension with double-stacked stack-integrated metallic optical elements 1491 forming high-aspect ratio optical resonators, according to one embodiment. The tunable metasurface 1400 can, for example, be used as part of a solid-state optical transmitter subsystem, receiver subsystem, or transceiver system of a software-defined lidar device. As illustrated, the tunable metasurface 1400 includes an optically reflective substrate 1490 and a dielectric layer 1495 (e.g., a via layer with conducive vias connecting portions of the optically reflective substrate 1490 to individual double-stacked metallic optical elements 1491.

The stack-integrated metallic optical elements 1491 form elongated rails that may be, for example, arranged at sub-wavelength intervals on the optically reflective substrate 1490. For example, each of the stack-integrated metallic optical elements 1491 may form elongated rectangular rails (tapered, non-tapered, tiered, or uniformly tapered). As illustrated, each stack-integrated metallic optical element 1491 comprises multiple metallic optical elements, including a base metallic optical element 1420 formed via a first damascene process (e.g., a single-damascene process or as part of a dual-damascene process with an earlier layer) and a stacked metallic optical element 1440 via a subsequent single-damascene process. As per the embodiments described in conjunction with FIGS. 8A-8F, a remnant of a metallic barrier 1430 (e.g., tantalum) from the subsequent single-damascene process remains unetched and connects the base metallic optical element 1420 and the stacked metallic optical element 1440.

Liquid crystal or another refractive index tunable dielectric material 1493 may be positioned between the stack-integrated metallic optical elements 1491, as described in the context of the various metasurfaces described in the references incorporated herein by reference. The metasurface 1400 can be used for beam steering in one direction, such that incident optical radiation can be selectively steered at various steering angles (e.g., as scan lines steered along a single axis).

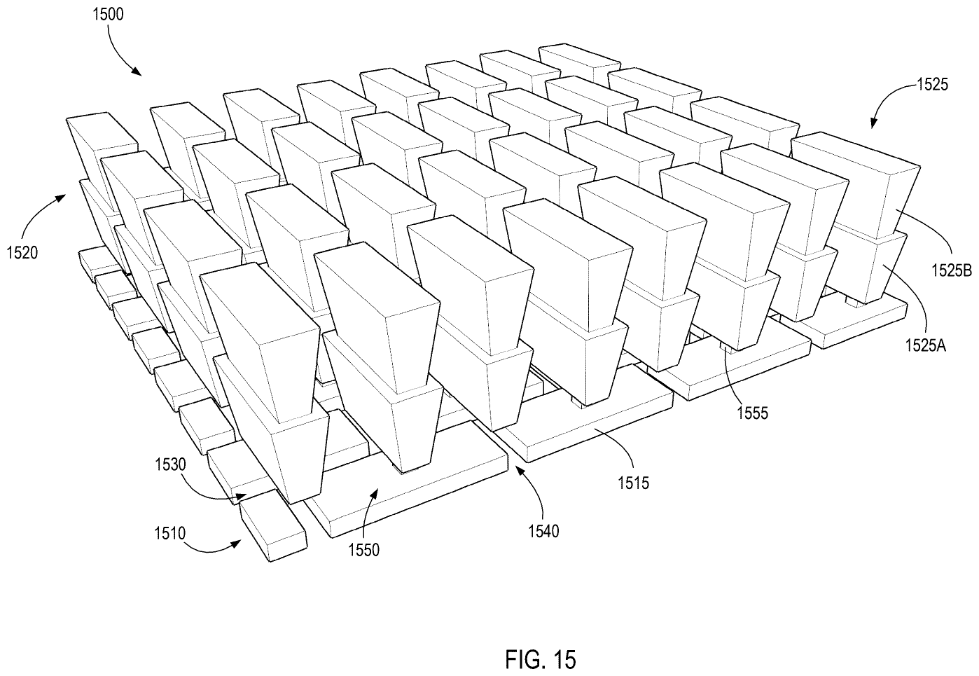

FIG. 15 illustrates a perspective view of a simplified block diagram of metasurface 1500 that is steerable in two directions, with stack-integrated metallic optical elements 1525 forming high-aspect ratio optical resonators, according to one embodiment. As illustrated, the resonator layer 1520 includes a two-dimensional array of metallic optical pillars, each of which comprises a metallic optical element 1525, arranged in parallel rows. Each metallic optical element 1525 metallic optical element 1525 comprises a base metallic optical element 1525A and a stacked metallic optical element 1525B. The base metallic optical elements 1525A stacked metallic optical element 1525B may be formed, for example, using the sequential single-damascene processes described according to any of the various embodiments detailed herein, including the embodiments described in conjunction with FIGS. 8A-F, FIGS. 10A-G, and/or FIGS. 12A-12F.

Each stack-integrated metallic optical element 1525 in the resonator layer 1520 extends vertically relative to an underlying substrate layer (not shown). The stack-integrated metallic optical elements 1525 in each row may be spaced from one another by less than a smallest wavelength in an operational bandwidth. The width (W) of each stack-integrated metallic optical element 1525 along each row may be less than one-half of the smallest wavelength of the operational bandwidth. The length (L) of each stack-integrated metallic optical element 1525 in a direction perpendicular to each row (e.g., along the columns) may be less than the smallest wavelength of the operational bandwidth.

The gaps between adjacent stack-integrated metallic optical elements 1525 in each row form optical resonators. A tunable dielectric material may be deposited within the resonator layer to fill the spaces between the stack-integrated metallic optical elements 1525 in all directions, such that tunable dielectric material is positioned within the optical resonators formed by the gaps between row-adjacent stack-integrated metallic optical elements 1525. Examples of suitable tunable dielectric materials that have tunable refractive indices include liquid crystals, electro-optic polymer, electro-optical crystals, chalcogenide glasses, and/or various semiconductor materials.

In alternative embodiments, the stack-integrated metallic optical elements 1525 in each row may be spaced from one another by more than a wavelength in an operational bandwidth (e.g., ten times the largest wavelength in the operational bandwidth). Similarly, in some embodiments, the width (W) of each stack-integrated metallic optical element 1525 along each row may be more than one-half of the smallest wavelength, and the length (L) of each stack-integrated metallic optical element 1525 in a direction perpendicular to each row (e.g., along the columns) may be many times larger than the largest wavelength of the operational bandwidth.

The reflective layer 1510 includes a two-dimensional array of elongated rectangular reflector patches 1515 extending lengthwise along parallel rows. That is, as illustrated, the reflector patches 1515 extend lengthwise in a direction that is perpendicular with respect to the lengthwise direction of the stack-integrated metallic optical elements 1525. An electrical isolation gap 1530 separates reflector patches 1515 in adjacent rows. An off-resonance gap 1540 separates adjacent reflector patches 1515 in the same row. The direction of the electrical isolation gap 1530 is off-resonance with the incident electric field so there is no resonant coupling. The off-resonance gap 1540 between adjacent reflector patches 1515 is perpendicular to the incident electrical field. Accordingly, the dimension of the off-resonance gap 1540 is selected to minimize or avoid any possible resonance between reflector patches 1515 in the same row, for a range of optical radiation wavelengths. The off-resonance gap 1540 may be a different size than the electrical isolation gap 1530.

A dielectric via layer 1550 may be positioned between the reflective layer 1510 and the resonator layer 1520. The dielectric via layer 1550 may, for example, be formed per the embodiments described in conjunction with FIGS. 7A-7G. Each stack-integrated metallic optical element 1525 may be electrically connected to one underlying reflector patch 1515 by a conductor via 1555 within the dielectric via layer 1550. The dielectric of the dielectric via layer 1550 has been removed from the figure for clarity to show the positioning of the conductor vias 1555.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. This disclosure should, therefore, be understood to encompass at least the following claims and all possible permutations thereof.

What is claimed:

1. An optical metasurface, comprising:
an optical reflector layer;
a resonator layer with an array of optical resonators that extend vertically with respect to the optical reflector layer, each optical resonator formed by two stack-integrated metallic optical elements positioned adjacent to one another to form a gap therebetween,
wherein each stack-integrated metallic optical element comprises at least:
a base metallic optical element, and
a first stacked metallic optical element; and
a tunable dielectric material that has a tunable refractive index positioned within the gap between the adjacent stack-integrated metallic optical elements of each respective optical resonator.

2. The metasurface of claim 1, wherein the base metallic optical element of each stack-integrated metallic optical element is formed during a first damascene manufacturing process, and
wherein the first stacked metallic optical element of each stack-integrated metallic optical element is formed during a subsequent damascene manufacturing process, and wherein at least the subsequent damascene manufacturing process is a single-damascene manufacturing process.

3. The metasurface of claim 1, wherein each stack-integrated metallic optical element extends to a height that is at least four times greater than a smallest width thereof, such that each stack-integrated metallic optical element has an aspect ratio of at least 4:1.

4. The metasurface of claim 3, wherein the base metallic optical element of each stack-integrated metallic optical element has an aspect ratio of at least 3:1, and the first stacked metallic optical element of each stack-integrated metallic optical element has an aspect ratio of at least 2:1, such that each stack-integrated metallic optical element has an aspect ratio of at least 5:1.

5. The metasurface of claim 1, further comprising a metallic barrier connection between the base metallic optical element and the first stacked metallic optical element of each stack-integrated metallic optical element.

6. The metasurface of claim 1, wherein each stack-integrated metallic optical element further comprises at least a second stacked metallic optical element, and wherein each of the base metallic optical element, the first stacked metallic optical element, and the second stacked metallic optical element have an aspect ratio of at least 2:1, such that each stack-integrated metallic optical element has an aspect ratio of at least 6:1.

7. The metasurface of claim 6, further comprising:
a first metallic barrier connection between the base metallic optical element and the first stacked metallic optical element of each stack-integrated metallic optical element; and
a second metallic barrier connection between the first stacked metallic optical element and the second stacked metallic optical element of each stack-integrated metallic optical element.

8. The metasurface of claim 1, wherein the base metallic optical element and a first stacked metallic optical element of each stack-integrated metallic optical comprise copper.

9. The metasurface of claim 1, wherein the optical reflector layer comprises a plurality of metallic reflector patches.

10. The metasurface of claim 9, further comprising:
an interconnect layer positioned between the optical reflector layer and the resonator layer, wherein the interconnect layer comprises a plurality of metallic vias, wherein each metallic via electrically connects to one of the stack-integrated metallic optical elements of the resonator layer.

11. The metasurface of claim 10, further comprising a plurality of conductive barrier patches, wherein each conductive barrier patch physically separates the base metallic optical element of each stack-integrated metallic optical element from the interconnect layer.

12. The metasurface of claim 11, wherein each conductive barrier patch comprises one or more of tantalum (Ta), tantalum nitride (TaN), and titanium nitride (TiN).

13. The metasurface of claim 1, wherein the array of optical resonators of the resonator layer comprises a two-dimensional array of optical resonators.

14. The metasurface of claim 13, wherein each stack-integrated metallic optical element in the two-dimensional array of optical resonators comprises a rectangular prism pillar.

15. The metasurface of claim 1, wherein the array of optical resonators of the resonator layer comprises a one-dimensional array of optical resonators.

16. The metasurface of claim 15, wherein each stack-integrated metallic optical element in the one-dimensional array of optical resonators comprises an elongated rectangular rail.

17. The metasurface of claim 1, wherein the tunable dielectric material comprises one or more of: liquid crystal, an electro-optic polymer, electro-optical crystal, and chalcogenide glass.

18. A method to manufacture an optical metasurface, comprising:
forming an optical reflector layer;
forming an interconnect layer above the optical reflector layer;
forming a resonator layer with an array of optical resonators, wherein each optical resonator is formed as two vertically extending stack-integrated metallic optical elements positioned adjacent to one another to form a gap therebetween,
wherein forming each stack-integrated metallic optical element comprises at least:
forming a base metallic optical element via a damascene process, and
forming a stacked metallic optical element on top of the base metallic optical element via a subsequent damascene process; and
positioning a tunable dielectric material that has a tunable refractive index positioned within the gap between the adjacent stack-integrated metallic optical elements of each respective optical resonator.

19. The method of claim 18, wherein the tunable dielectric material comprises one or more of: liquid crystal, an electro-optic polymer, electro-optical crystal, and chalcogenide glass.

20. The method of claim 18, wherein the subsequent damascene process to form the stacked metallic optical element is a single-damascene process that includes a deposition of a conductive barrier, and wherein a portion of the conductive barrier remains unetched to connect the base metallic optical element and the stacked metallic optical element.

21. The method of claim 18, wherein the optical reflector layer is formed to include a plurality of metallic reflector patches.

22. The method of claim 18, wherein the forming the interconnect layer above the optical reflector layer comprises forming a plurality of metallic vias, an interconnect dielectric etch-stop layer, an interconnect dielectric mid-layer, and an etch-resistant dielectric cap layer.

23. The method of claim 18, wherein forming the stacked metallic optical element on top of the base metallic optical element via the subsequent damascene process comprises an electroless deposition of copper directly on an exposed upper surface of the base metallic optical element.

24. The method of claim 18, wherein the subsequent damascene process to form the stacked metallic optical element includes a selective deposition of a conductive barrier material on dielectric surfaces without deposition on an upper surface of the base metallic optical element.
